(19) United States
(12) Patent Application Publication
(10) Pub. No.: US 2026/0040003 A1
(43) Pub. Date: Feb. 5, 2026

(54) POWER MANAGEMENT FOR AUDIO PLAYBACK DEVICES

(71) Applicant: Sonos, Inc., Goleta, CA (US)

(72) Inventors: Joern Riemer, Trabuco Canyon, CA (US); James Nesfield, Edinburgh (GB); Matthew Benatan, Stockport (GB); Adib Mehrabi, London (GB)

(21) Appl. No.: 18/997,597

(22) PCT Filed: Jul. 21, 2023
(86) PCT No.: PCT/US2023/070771

§ 371 Date: Jan. 22, 2025

Related U.S. Application Data
(60) Provisional application No. 63/369,169, filed on Jul. 22, 2022.
(60) Provisional application No. 63/492,588, filed on Mar. 28, 2023.
(60) Provisional application No. 63/506,329, filed on Jun. 5, 2023.

(51) Int. Cl. H04R 3/12

(52) U.S. Cl. CPC H04R 3/12; H04R 2420/07

(57) ABSTRACT

Disclosed herein are systems and methods for power transmission between playback devices, systems and methods for energy harvesting and distribution for audio playback devices, and systems and methods for wirelessly powering wearable audio playback devices.

### CROSS-REFERENCE TO RELATED APPLICATIONS

This application claims priority to U.S. Provisional Application No. 63/369,169, filed Jul. 22, 2022: U.S. Provisional Application No. 63/492,588, filed Mar. 28, 2023; and U.S. Provisional Application No. 63/506,329, filed Jun. 5, 2023, each of which is hereby incorporated by reference in its entirety.

### FIELD OF THE DISCLOSURE

The present disclosure is related to consumer goods and, more particularly, to methods, systems, products, features, services, and other elements directed to media play back or some aspect thereof.

### BACKGROUND

Options for accessing and listening to digital audio in an out-loud setting were limited until in 2002, when SONOS, Inc, began development of a new type of playback system. Sonos then filed one of its first patent applications in 2003, entitled “Method for Synchronizing Audio Playback between Multiple Networked Devices,” and began offering its first media play back systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked play back device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media play back system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media play back system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows a front view of a control device.

FIG. 6 shows a message flow diagram of a media playback system.

FIG. 7 shows an example configuration of a wireless power transfer device in accordance with the disclosed technology.

FIG. 8 shows an example configuration of a wireless power group in accordance with the disclosed technology.

FIG. 9A is a schematic illustration of a media play back system including mountable playback devices in accordance with the disclosed technology.

FIG. 9B is a schematic illustration of a portion of the media playback system of FIG. 9A with a cover of the mountable playback device omitted for clarity.

FIG. 10 illustrates an example frequency response curve for a mountable playback device operating in a first mode in accordance with the disclosed technology.

FIG. 11 illustrates example frequency response curves for a mountable playback device and a stationary plug-in playback device operating in a second mode in accordance with the disclosed technology.

FIG. 12 is a flow diagram of an example method for power-based audio playback management in accordance with the disclosed technology.

FIG. 13 illustrates an example system for harvesting and distributing energy among playback devices in accordance with the disclosed technology.

FIGS. 14-16 illustrate example methods for energy harvesting and distribution in accordance with the disclosed technology.

FIG. 17 illustrates an example method for energy management for audio playback devices in accordance with the disclosed technology.

FIG. 18 shows an example arrangement for wireless power transfer between an accessory power device and a playback device in accordance with examples of the present technology.

FIGS. 19A-19D illustrate example form factors for wearable playback devices in accordance with the disclosed technology.

FIGS. 20A-20F illustrate example form factors for accessory power devices in accordance with the disclosed technology.

FIGS. 21 and 22 illustrate example methods for wireless power transfer between an accessory power device and a playback device in accordance with the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Audio playback devices that can be mounted to a wall, such as playback devices having a flat panel form factor, provide several benefits. For example, such low-profile playback devices can be relatively inconspicuous, easy to position at a desired position within a room, and, in some instances, can be disguised or integrated with home decor. Such devices do present certain drawbacks, however, as they are generally unable to output significant bass frequencies. Moreover, when such playback devices are mounted to a wall, an unsightly power cable may need to be run from the playback device to an adjacent power outlet located lower on the wall.

The present technology addresses these and other problems by providing a playback device such as a mountable play back device having an on-board energy storage (e.g., a battery, ultracapacitor, etc.). The mountable playback device can cooperate with an adjacent primary playback device, such as a plugged-in subwoofer or other playback device. The primary playback device can transmit power to the mountable playback device, either via wireless transmission or via a physical cable extending between the mountable play back device and the primary playback device. In implementations in which the mountable playback device has an on-board energy storage, the physical cable connecting the mountable play back device and the primary playback device can be thinner than would otherwise be required, and accordingly may be more inconspicuous. Such a physical cable can optionally be a low-voltage, low-current cable that charges the onboard energy storage of the mountable playback device over time. During playback via the mountable play back device, peak power output periods (e.g., output of audio with high bass levels, or high-volume audio playback) can draw on the energy storage, as the power needs for such output can exceed the power provided via the physical cable. In some examples, the physical cable can be coupled to a mounted bracket or other receptacle that is attached to the mounting surface (e.g., a wall). Optionally, delivery of charging power via the physical cable (or via wireless transmission) can be scheduled based on user input, device usage, electricity prices, or any other suitable parameter.

When the mountable playback device is coupled to the bracket, an electrical connection can be established such that the mountable play back device receives power (and/or data) via the physical cable. When the mountable playback device is removed from the bracket (e.g., to be temporarily placed at another location), the mountable playback device may rely instead on its onboard energy storage (and/or any wireless power received from a nearby wireless power transmitter).

Additionally, playback responsibilities assigned to the mountable playback device may be dynamically modified depending on a number of factors, such as a remaining energy storage level of the mountable play back device, the particular audio content being played back, the power-consumption rate of the mountable playback device, or other relevant parameters. For example, as the energy storage level of the mountable playback device falls below a predetermined threshold, the audio playback can be modified to reduce power consumption and preserve some playback capability for a longer duration. Bass-heavy audio output is particularly power-intensive, and as such modifying the audio playback to include less low-frequency audio output can extend the playback time of a mountable playback device with a lower level of stored power. However, reducing the low-frequency output of the mountable play back device can also lead to a diminished user experience. Accordingly, it can be useful to augment or supplement the modified audio output by the portable playback device by synchronously playing back audio via another nearby playback device, such as the primary playback device (e.g., a subwoofer). For example, consider a scenario in which a user is listening to audio on a mountable playback device positioned on a living room wall, while a plugged-in subwoofer playback device is positioned nearby (and optionally coupled to the mountable playback device via a physical cable). In response to the battery level of the mountable playback device dropping below a threshold, the mountable playback device can transition to a second mode in which less low-frequency audio content is output by the mountable play back device, while simultaneously the nearby plugged-in subwoofer play back device can begin to synchronously output low-frequency audio content to augment the audio being played back by the mountable playback device. In this manner, the low-frequency audio content is still output for the user, while the mountable playback device reduces its power consumption and extends its play back time before needing to be recharged. Moreover, because low-frequency content is more omnidirectional than higher-frequency content, the user may be less able to localize the source of the low-frequency content as coming from the nearby plugged-in subwoofer playback device rather than the mountable playback device.

In some implementations, the primary playback device (e.g., a subwoofer) and the mountable play back device can be grouped together as a bonded zone, in which audio is played back synchronously via the two devices. The mountable playback device can play back audio comprising primarily or exclusively frequencies above a crossover frequency, while the primary playback device can play back audio comprising primarily or exclusively frequencies below a crossover frequency. To adjust the relative playback responsibilities of the two devices, the crossover frequency may be varied over time depending on the remaining energy storage level of the mountable play back device, the power-consumption rate of the mountable play back device, a wireless power receipt parameter, or any other relevant parameter.

In various examples, the offloading of low-frequency audio content from a mountable playback device to one or more other playback devices within the environment can be based on a power parameter of the mountable playback device (e.g., energy storage level, power consumption rate, etc.), a power parameter of the mountable playback device (e.g., whether the nearby device is a stationary plugged-in device, the charge level of the nearby play back device etc.), a proximity parameter (e.g., a distance between the playback devices), a battery temperature (since batteries tend to be more efficient at higher temperatures), or any other suitable parameter. Additionally or alternatively to modifying the acoustic output, certain operations of the mountable playback device may also be modified depending on energy storage levels. For example, when energy storage levels fall below a predetermined threshold, certain functions can be disabled (e.g., turning off microphones, disabling a Bluetooth antenna, etc.).

Another aspect of the present technology relates to the fact that playback devices in a media play back system (MPS) are typically in an active state (e.g., playing back media content) during only a small percentage of a day (e.g., 15% or about 4 hours). Over the remaining time, the devices may run in an idle state. Devices in an idle state, however, still consume a non-negligible amount of energy to perform background tasks, such as monitoring microphone data for voice assistant service activation words and communicating state information to other devices in the MPS. One approach to power management is to limit grid power (i.e., power received via a power cord or plug-in charger) to times when a device is in an active state, and rely on harvested energy (e.g., energy derived from solar panels or other energy harvesters) to provide the required energy while the device is an idle state. For instance, it may be possible for relatively compact solar panels with sufficient exposure to the sun to generate enough energy (e.g., 2 watts or less) to continuously power an idle playback device. Most playback devices, however, are placed indoors and away from windows such that even in the best conditions, indoor solar power reliably provides less than 1/50th of the requisite power for a play back device operating in an idle state. Similarly for other types of energy harvesters (e.g., thermal, kinetic, wind, etc.), some playback devices may be better positioned than others to capture energy from the environment.

To address these and other problems, an energy harvester device can be placed in a position beneficial for energy harvesting, and may then transmit power to external receiver devices within the environment. For example, a playback device equipped with solar panels and a large energy storage device (e.g., one or more batteries) can be placed near a window indoors or perhaps outside unobstructed. The energy harvester device can be configured to wirelessly transmit energy to one or more external playback devices within the environment. As such, the energy captured via the energy harvester device is distributed to adjacent play back devices, which may provide some or all of the power needed for each device to run while in an idle state. As used herein, an “energy harvester device” can include any device with energy harvesting components that is configured to obtain or derive energy from the environment rather than from the power grid. Such devices can take the form of dedicated energy harvester devices or audio playback devices equipped with energy harvesting capabilities.

Additional aspects of the present technology relate to wearable audio playback devices (e.g., headphones, earbuds), which often include an integrated battery to facilitate wireless operation. While convenient to a user, this form factor presents certain challenges with respect to repairability and accordingly can contribute to the generation of electronic waste. Certain wearable audio playback devices, such as in-ear devices (e.g., wireless earbuds) can be particularly difficult to repair. In an effort to make earbuds as watertight as possible, adhesives and bonding techniques are often used to permanently seal the enclosures, which hinders access to the interior of the devices. Even if the devices are ultimately able to be opened and repaired, the process can be time-intensive and usually requires expertise such that when accounting for labor costs, the total expense to repair the device is often more than simply buying a replacement.

In the case of in-ear devices, the battery is the component that most often needs to be repaired or replaced. Many batteries designed for in-ear devices, for instance, typically have a 3-year lifespan. The remaining components (e.g., electronics, transducers, sensors, microphones) can be expected to last several years longer. Nevertheless, many in-ear devices are discarded in landfills once the initial battery expires because the devices are incapable of being easily serviced. Furthermore, even in the rare instances in which the in-ear devices are capable of being easily repaired, the batteries themselves are difficult to recycle due to their relatively small size.

Various examples of the present technology address these and other problems by enabling wireless power transfer to a wearable device. This approach can extend the battery life of a wearable device, such as a wearable audio playback device, and/or permit a smaller battery to be used in a given wearable audio playback device. In some implementations, a wearable audio playback device such as an in-ear device can be configured to receive at least some of its power from a separate accessory power device, instead of or in addition to power drawn from an integrated battery. Such an accessory power device can take the form of a wearable component (e.g., neckband, bracelet, earring, clip-on device, backpack, etc.) that houses one or more batteries (or other energy storage components such as capacitors) and is configured to supply power (e.g., via wireless power transfer) to the wearable audio playback device. Optionally, an accessory power device may omit its own internal battery, and may instead receive wireless power from another transmitter device and in turn transmit wireless power to the wearable audio playback device, thereby serving as a wireless power relay device. By utilizing at least some power derived from the accessory power device, the wearable audio playback device may consume power at a lower rate, thereby extending battery life. Additionally or alternatively, the wearable audio playback device may be able to perform additional functions due to the increase in available power (e.g., increasing the maximum playback time before recharging is required, increasing output volume, etc.). In some implementations, due to the larger battery capacity (and likely larger size) of the accessory power device, the accessory power device can have improved ease of repairability and higher likelihood of eventual battery recycling. Further, removing the battery and potentially other components from the wearable audio playback device remove mass and thereby facilitate designs that are more susceptible to repair by end users and potentially more comfortable for wearers. Additionally, as the battery is typically the most common source of failure in wearable audio playback devices, the present technology may reduce the need for repair altogether.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

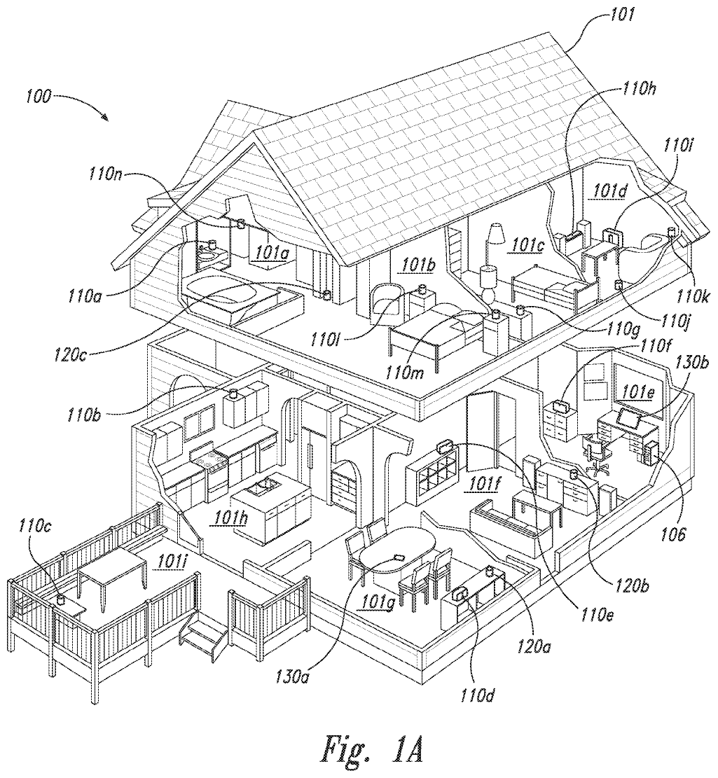

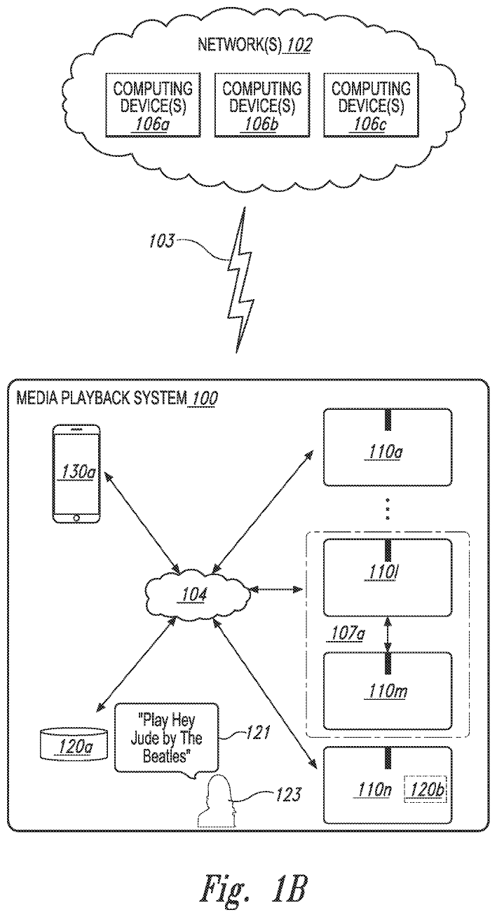

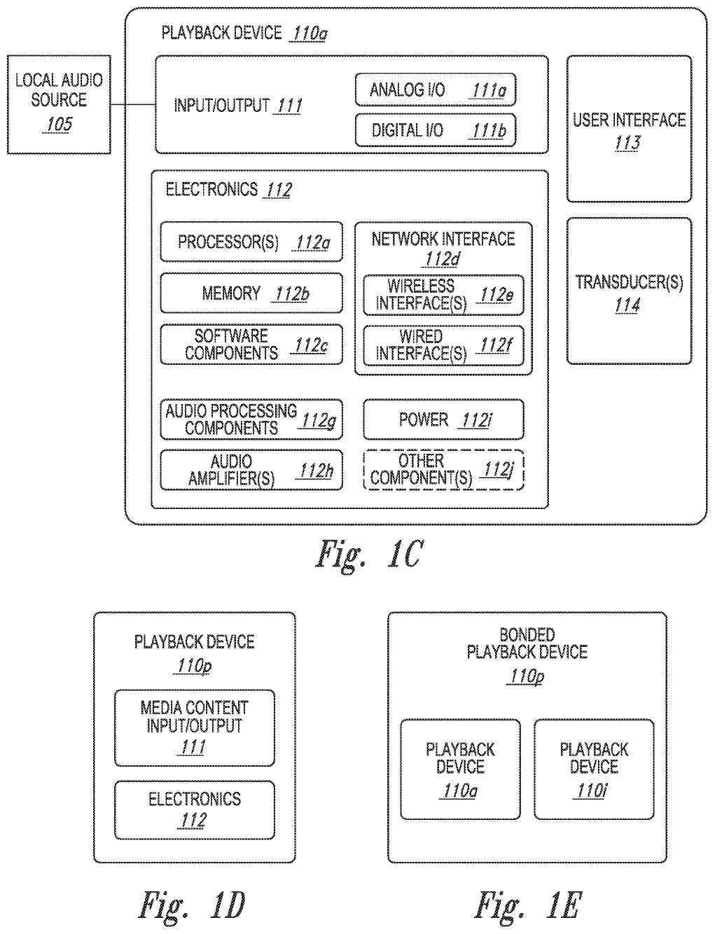

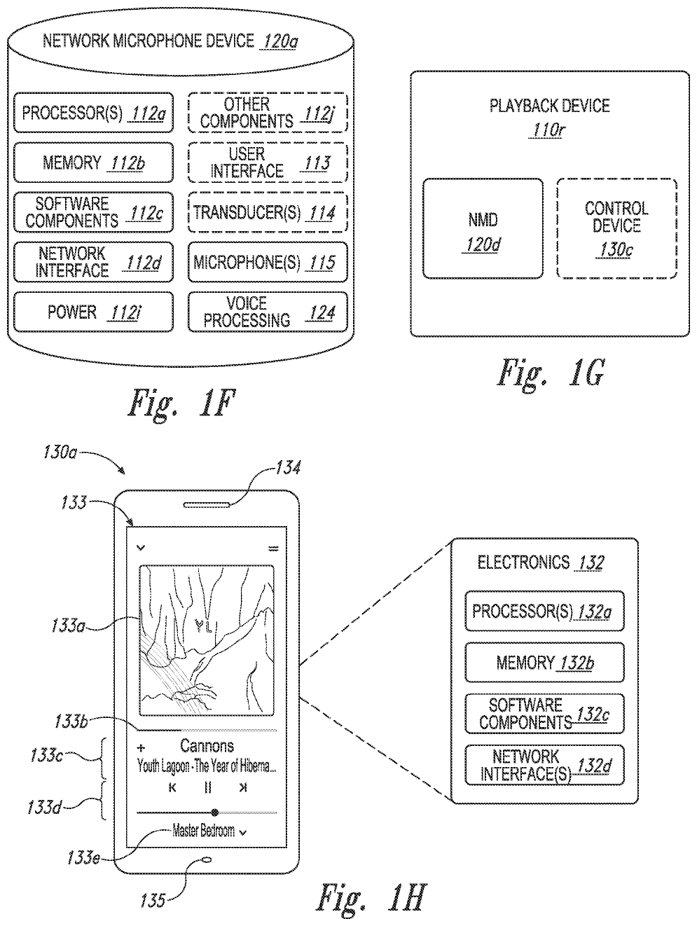

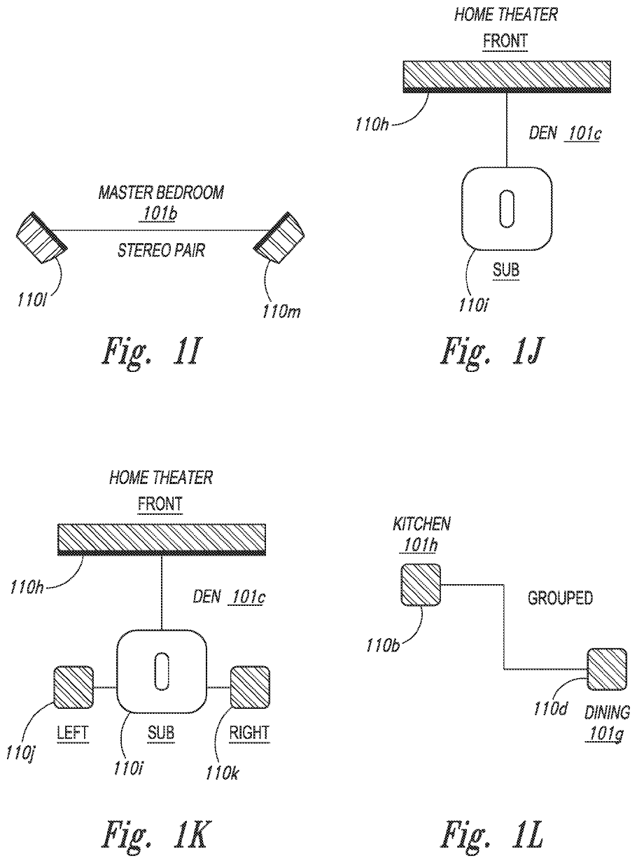

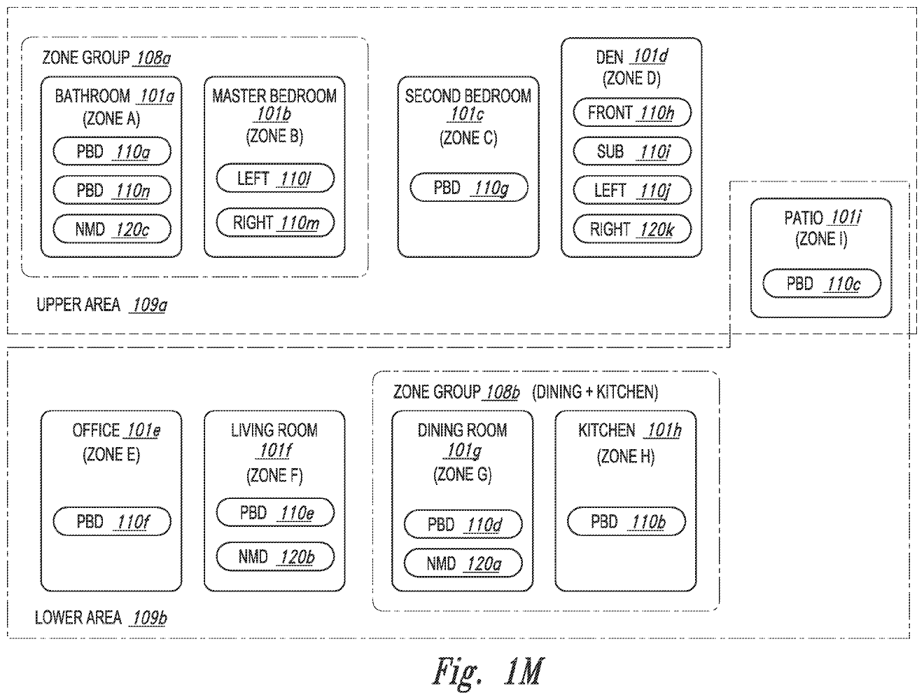

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media play back system 100 distributed in an environment 101 (e.g., a house). The media play back system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “play back device” can generally refer to a network device configured to receive, process, and output data of a media playback system. For example, a playback device can be a network device that receives and processes audio content. In some embodiments, a play back device includes one or more transducers or speakers powered by one or more amplifiers. In other embodiments, however, a playback device includes one of (or neither of) the speaker and the amplifier. For instance, a play back device can comprise one or more amplifiers configured to drive one or more speakers external to the play back device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media play back system 100 can play back audio via one or more of the play back devices 110. In certain embodiments, the playback devices 110 are configured to commence play back of media content in response to a trigger. For instance, one or more of the play back devices 110 can be configured to play back a morning playlist upon detection of an associated trigger condition (e.g., presence of a user in a kitchen, detection of a coffee machine operation). In some embodiments, for example, the media play back system 100 is configured to play back audio from a first playback device (e.g., the playback device 100a) in synchrony with a second playback device (e.g., the playback device 100b). Interactions between the playback devices 110, NMDs 120, and/or control devices 130 of the media play back system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media play back system 100 can comprise one or more playback zones, some of which may correspond to the rooms in the environment 101. The media play back system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of play back devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded play back devices, and/or as one or more consolidated playback devices. Additional details regarding bonded and consolidated play back devices are described below with respect to, for example, FIGS. 1B and 1E and 1I-1M.

In some aspects, one or more of the play back zones in the environment 101 may each be playing different audio content. For instance, a user may be grilling on the patio 101i and listening to hip hop music being played by the playback device 110c while another user is preparing food in the kitchen 101h and listening to classical music played by the play back device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different play back zones. Additional details regarding audio playback synchronization among play back devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous play back, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the play back device to generate playback timing information for the audio content, (iii) transmitting portions of the audio content and play back timing for the portions of the audio content to at least one other play back device (e.g., at least one other playback device operating in an audio playback group member mode). (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and play back timing for the audio content from the at least one other device (e.g., a play back device operating in an audio playback group coordinator mode): (ii) receiving timing information from the at least one other device (e.g., a play back device operating in an audio playback group coordinator mode); and/or (iii) playing the audio content in synchrony with at least the other play back device using the play back timing for the audio content and/or the timing information.

a. Suitable Media Playback System

FIG. 1B is a schematic diagram of the media play back system 100 and a cloud network 102. For ease of illustration, certain devices of the media play back system 100 and the cloud network 102 are omitted from FIG. 1B. One or more communication links 103 (referred to hereinafter as “the links 103”) communicatively couple the media play back system 100 and the cloud network 102.

The links 103 can comprise, for example, one or more wired networks, one or more wireless networks, one or more wide area networks (WAN) (e.g., the Internet), one or more local area networks (LAN) (e.g., one or more WIFI networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks. Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g, voice input data) from the media playback system 100 and correspondingly transmit commands and/or media content to the media play back system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media play back system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media play back system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet. Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n. 802.11ac, 802.11ac, 802.11ad, 802.11af, 802.11ah, 802.11ai, 802.11aj, 802.11aq, 802.11ax. 802.1 lay, 802.15, etc, transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media play back system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media play back system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media play back system 100. In some embodiments, for example, the media play back system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the play back devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media play back system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through 1M.

The media play back system 100 includes the NMDs 120a and 120d, each comprising one or more microphones configured to receive voice utterances from a user. In the illustrated embodiment of FIG. 1B, the NMD 120a is a standalone device and the NMD 120d is integrated into the play back device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE®, APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media play back system 100 to play back “Hey Jude” by the Beatles from a suitable media service (e.g., via one or more of the computing devices 106) on one or more of the play back devices 110.

b. Suitable Playback Devices

FIG. 1C is a block diagram of the play back device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi. Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media play back system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils. Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the play back device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more play back devices 110 to enable a multi-channel audio environment (e.g., a stereo pair, a bonded zone).

The processors 112a can be further configured to perform operations causing the play back device 110a to synchronize play back of audio content with another of the one or more play back devices 110. As those of ordinary skill in the art will appreciate, during synchronous play back of audio content on a plurality of play back devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the play back device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the play back device 110a. The memory 112b can also include data associated with a state of one or more of the other devices (e.g., the play back devices 110, NMDs 120, control devices 130) of the media play back system 100. In some aspects, for example, the state data is shared during predetermined intervals of time (e.g., every 5 seconds, every 10 seconds, every 60 seconds) among at least a portion of the devices of the media play back system 100, so that one or more of the devices have the most recent data associated with the media play back system 100.

The network interface 112d is configured to facilitate a transmission of data between the play back device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth. LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz. “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 KHz.

By way of illustration, SONOS, Inc, presently offers (or has offered) for sale certain play back devices including, for example, a “SONOS ONE,” “PLAY:1,” “PLAY:3,” “PLAY:5,” “PLAYBAR,” “PLAYBASE,” “CONNECT: AMP,” “CONNECT,” and “SUB,” Other suitable playback devices may additionally or alternatively be used to implement the playback devices of example embodiments disclosed herein. Additionally, one of ordinary skilled in the art will appreciate that a play back device is not limited to the examples described herein or to SONOS product offerings. In some embodiments, for example, one or more playback devices 110 comprises wired or wireless headphones (e.g., over-the-ear headphones, on-ear headphones, in-ear earphones). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more of earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., ear-level devices) that are configured to provide a hearing enhancement function while also supporting play back of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the play back devices 110 comprise a docking station and/or an interface configured to interact with a docking station for personal mobile media playback devices. In certain embodiments, a play back device may be integral to another device or component such as a television, a lighting fixture, or some other device for indoor or outdoor use. In some embodiments, a play back device omits a user interface and/or one or more transducers. For example, FIG. 1D is a block diagram of a playback device 110p comprising the input/output 111 and electronics 112 without the user interface 113 or transducers 114.

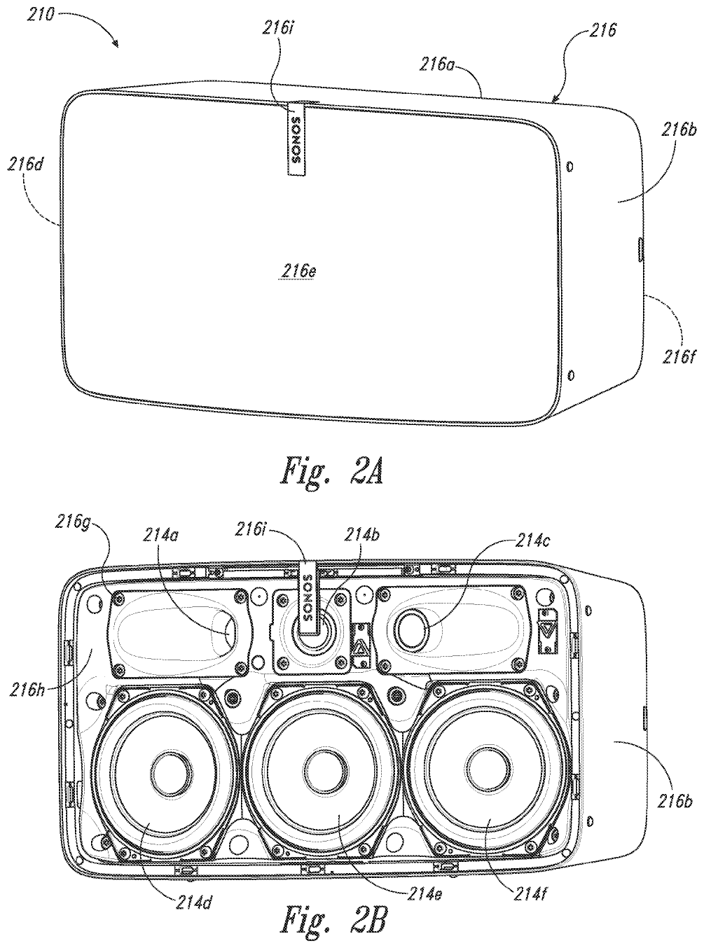

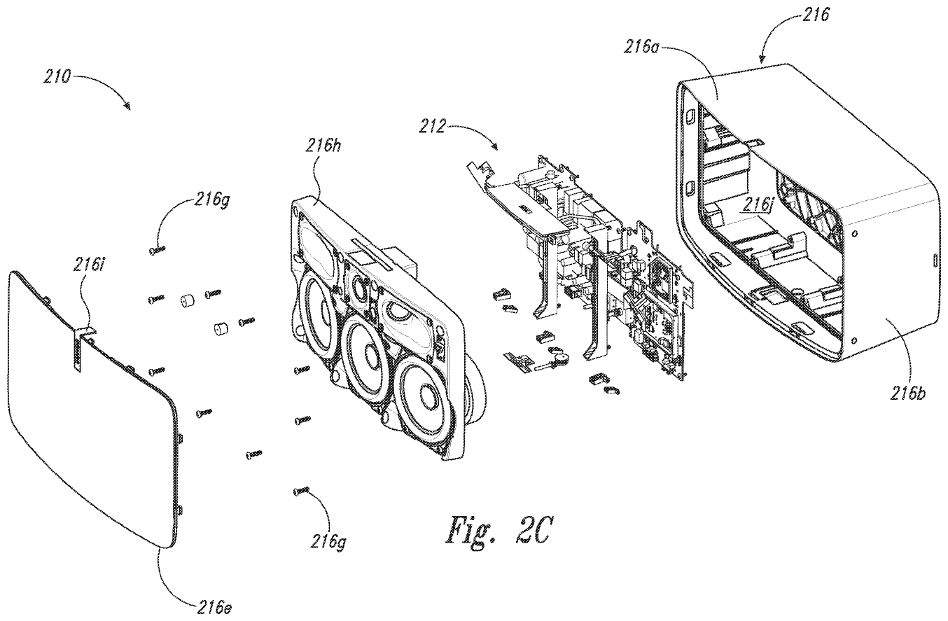

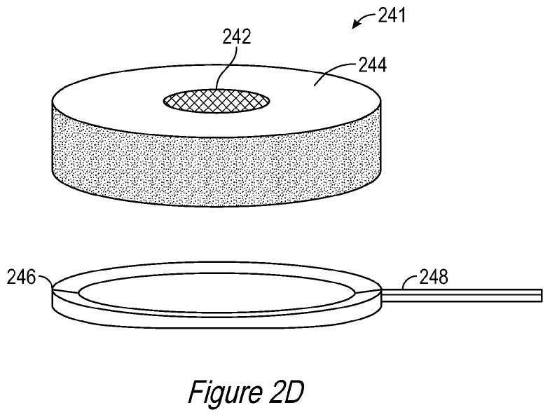

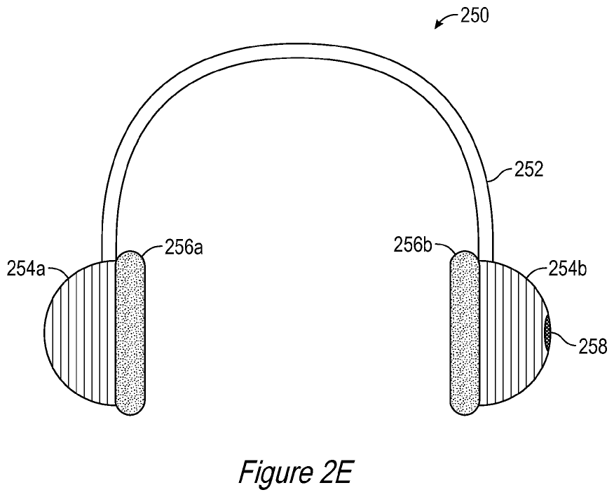

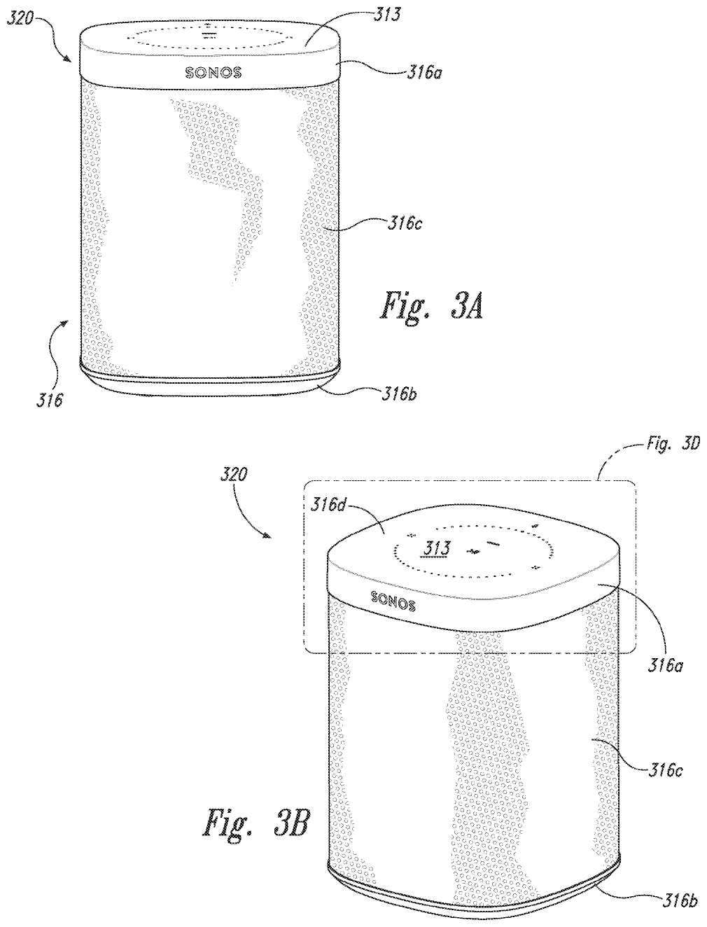

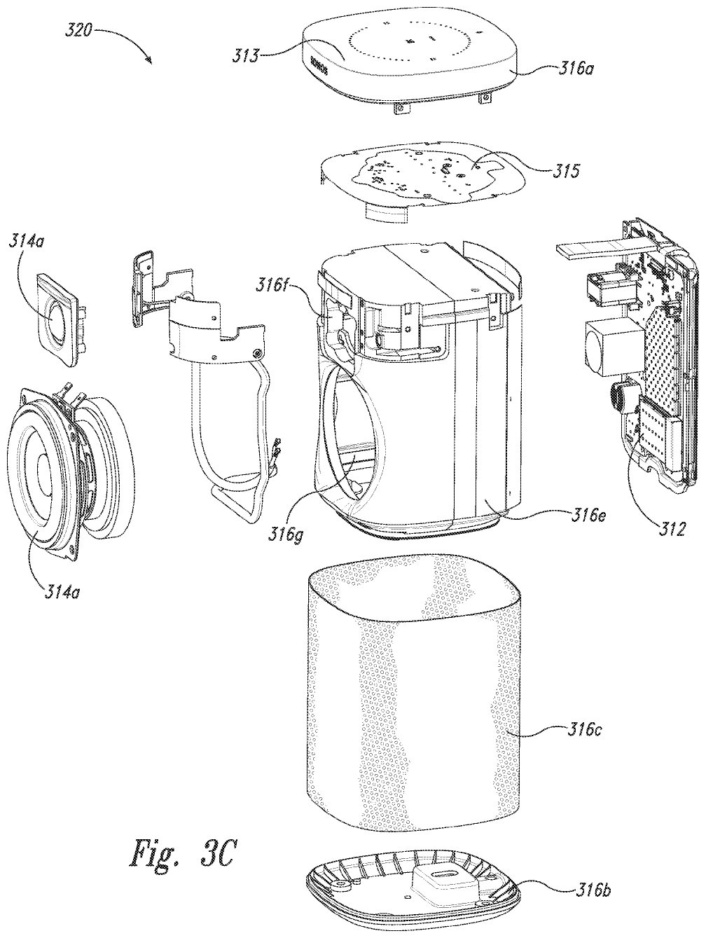

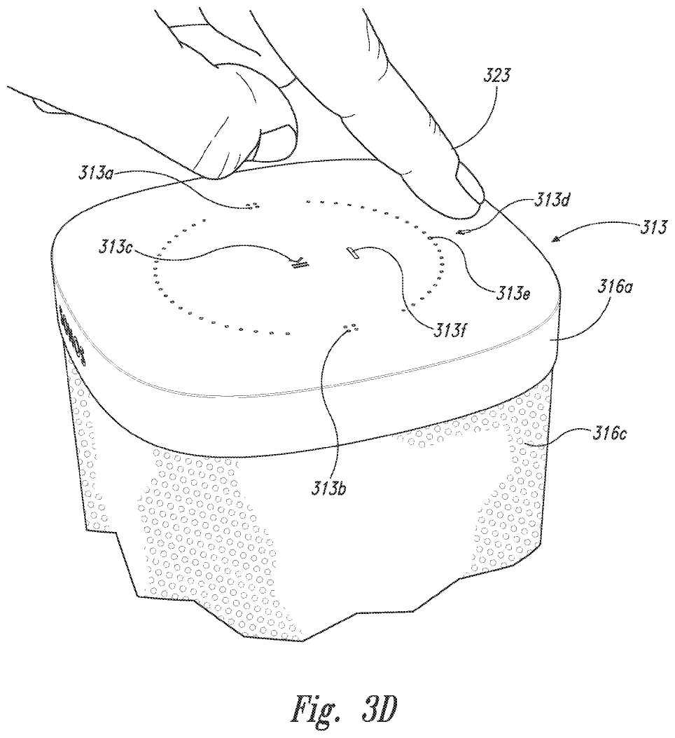

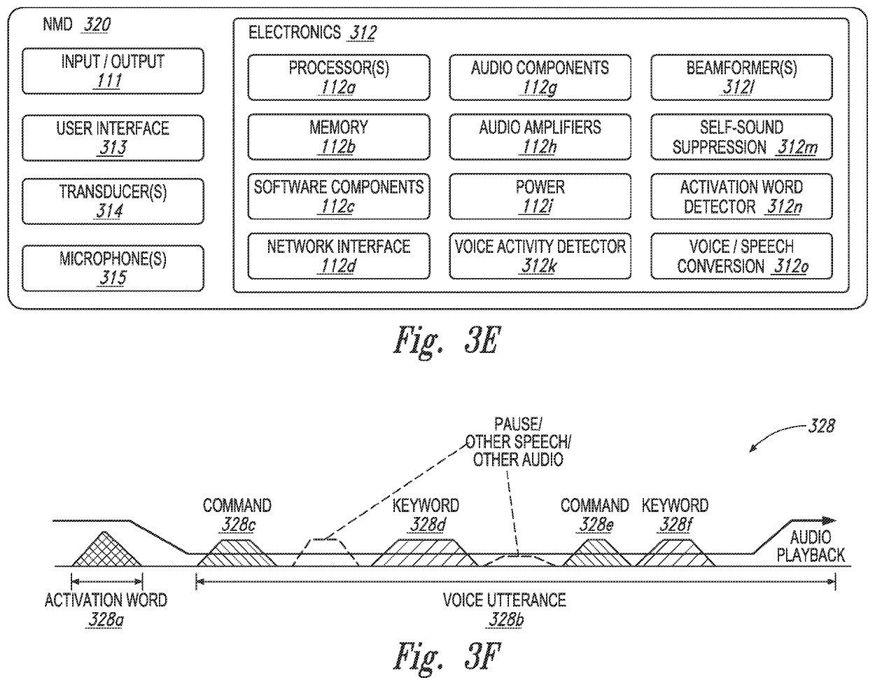

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the play back devices 110a and 110i are separate ones of the playback devices 110 housed in separate enclosures. In some embodiments, however, the bonded playback device 110q comprises a single enclosure housing both the play back devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the play back device 110a, when bonded with the first playback device, is configured to render only the mid-range and high frequency components of a particular audio content, while the play back device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the play back device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the play back device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The play back device 110r can comprise many or all of the components of the playback device 110a and further include the microphones 115 and voice processing 124 (FIG. 1F). The play back device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system,” Among other features, the control device 130a is configured to receive user input related to the media play back system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media play back system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media play back system 100. In other embodiments, as described above with respect to FIG. 1G, the control device 130a is integrated into another device in the media play back system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media play back system controller application software, and/or other data associated with the media play back system 100 and the user.

The network interface 132d is configured to facilitate network communications between the control device 130a and one or more other devices in the media play back system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media play back systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate ‘control of the media play back system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more play back devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the play back devices 110). Similarly, in some embodiments the control device 130a is configured as an NMD (e.g., one of the NMDs 120), receiving voice commands and other sounds via the one or more microphones 135.

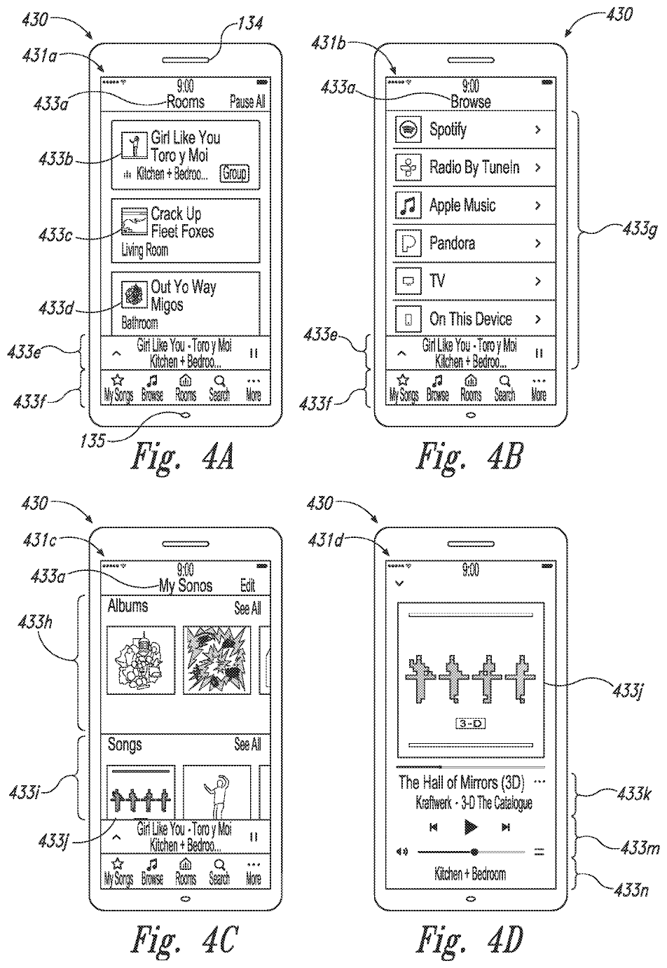

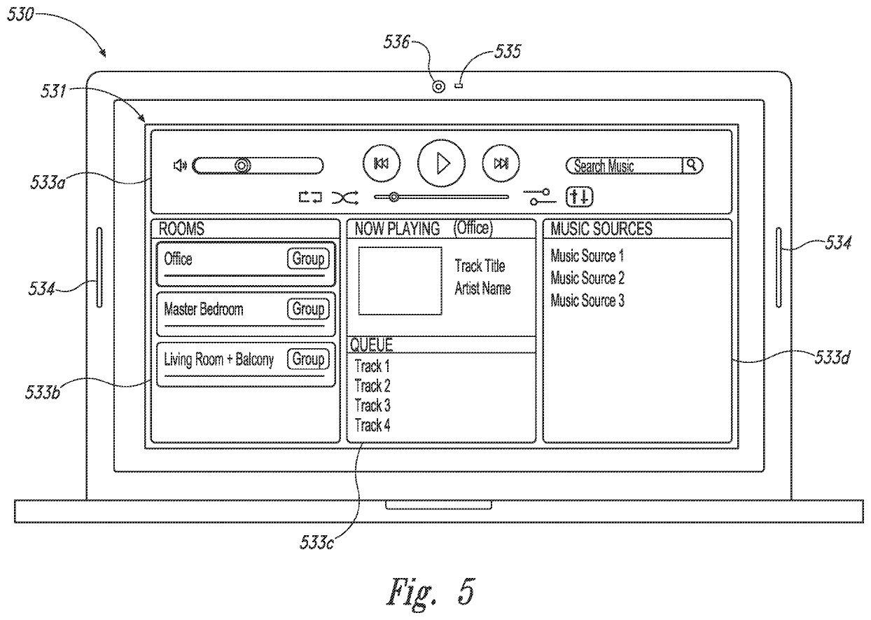

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-I through 1M show example configurations of play back devices in zones and zone groups. Referring first to FIG. 1M, in one example, a single play back device may belong to a zone. For example, the playback device 110g in the second bedroom 101c (FIG. 1A) may belong to Zone C. In some implementations described below, multiple play back devices may be “bonded” to form a “bonded pair” which together form a single zone. For example, the playback device 1101 (e.g., a left playback device) can be bonded to the play back device 1101 (e.g., a left playback device) to form Zone A. Bonded play back devices may have different playback responsibilities (e.g., channel responsibilities). In another implementation described below, multiple play back devices may be merged to form a single zone. For example, the playback device 110h (e.g., a front playback device) may be merged with the playback device 110i (e.g., a subwoofer), and the play back devices 110j and 110k (e.g., left and right surround speakers, respectively) to form a single Zone D. In another example, the play back devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media play back system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different play back responsibilities, such as responsibilities for certain audio channels. For example, as shown in FIG. 1-I, the play back devices 110l and 110m may be bonded so as to produce or enhance a stereo effect of audio content. In this example, the playback device 110l may be configured to play a left channel audio component, while the play back device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the play back device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the play back devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Play back devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 1M. In some embodiments, a zone group may be given a unique name selected by a user.

Certain data may be stored in a memory of a play back device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “bl” to identify playback device(s) that may be bonded in the zone, and a third type “cl” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media play back system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system,” Each of these applications is incorporated herein by reference in its entirety. In some embodiments, the media play back system 100 may not implement Areas, in which case the system may not store variables associated with Areas.

### III. Example Systems and Devices

FIG. 2A is a front isometric view of a play back device 210 configured in accordance with aspects of the disclosed technology. FIG. 2B is a front isometric view of the play back device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 KHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the play back device 210 includes a number of transducers different than those illustrated in FIGS. 2A-2C. For example, as described in further detail below with respect to FIGS. 3A-3C, the play back device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the play back device 210 may be constructed as a portable play back device, such as an ultra-portable playback device, that comprises an internal power source. FIG. 2D shows an example housing 241 for such a portable play back device. As shown, the housing 241 of the portable play back device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable play back device without the use of conductive contacts. For example, the dock 246 may wirelessly charge the portable playback device via one or more inductive coils integrated into each of the dock 246 and the portable playback device.

In some examples, the playback device 210 may take the form of a wired and/or wireless headphone (e.g., an over-ear headphone, an on-ear headphone, or an in-ear headphone). For instance, FIG. 2E shows an example housing 250 for such an implementation of the play back device 210. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy source and weigh less than fifty ounces.

In some examples, the playback device 210 may take the form of an in-ear headphone device. It should be appreciated that the playback device 210 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the play back device 210 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of play back and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other play back devices and/or computing devices rather than those described herein. Further, although a specific example of play back device 210 is described with reference to MPS 100, one skilled in the art will recognize that playback devices as described herein can be used in a variety of different environments, including (but not limited to) environments with more and/or fewer elements, without departing from this invention. Likewise, MPSs as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson,” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 3121, acoustic echo cancellation (AEC) and/or self-sound suppression components 312m, activation word detector components 312n, and voice/speech conversion components 3120 (e.g., voice-to-text and text-to-voice). In the illustrated embodiment of FIG. 3E, the foregoing components 312k-3120 are shown as separate components. In some embodiments, however, one or more of the components 312k-3120 are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media play back systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXAR. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify. Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a play back queue.

The play back zone region 533b can include representations of play back zones within the media play back system 100 (FIGS. 1A and 1B). In some embodiments, the graphical representations of play back zones may be selectable to bring up additional selectable icons to manage or configure the play back zones in the media play back system, such as a creation of bonded zones, creation of zone groups, separation of zone groups, renaming of zone groups, etc. In the illustrated embodiment, a “group” icon is provided within each of the graphical representations of play back zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a play back zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the play back queue region 533d. The graphical representations may include track title, artist name, album name, album year, track length, and other relevant information that may be useful for the user to know when controlling the media play back system 100 via the user interface 531.

The play back queue region 533d includes graphical representations of audio content in a playback queue associated with the selected playback zone or zone group. In some embodiments, each playback zone or zone group may be associated with a playback queue containing information corresponding to zero or more audio items for playback by the play back zone or zone group. For instance, each audio item in the playback queue may comprise a uniform resource identifier (URI), a uniform resource locator (URL) or some other identifier that may be used by a play back device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the play back queue. In some embodiments, audio items in a play back queue may be saved as a playlist. In certain embodiments, a play back queue may be empty, or populated but “not in use” when the playback zone or zone group is playing continuously streaming audio content, such as Internet radio that may continue to play until otherwise stopped, rather than discrete audio items that have playback durations. In some embodiments, a play back queue can include Internet radio and/or other streaming audio content items and be “in use” when the playback zone or zone group is playing those items.

When playback zones or zone groups are “grouped” or “ungrouped,” play back queues associated with the affected playback zones or zone groups may be cleared or re-associated. For example, if a first play back zone including a first play back queue is grouped with a second playback zone including a second playback queue, the established zone group may have an associated playback queue that is initially empty, that contains audio items from the first playback queue (such as if the second playback zone was added to the first play back zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

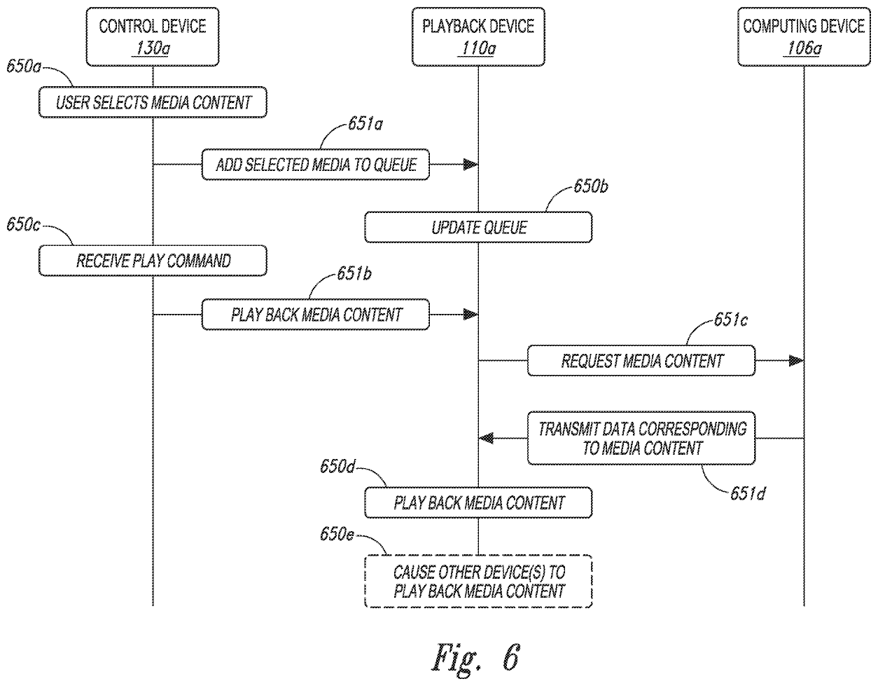

FIG. 6 is a message flow diagram illustrating data exchanges between devices of the media play back system 100 (FIGS. 1A-1M).

At step 650a, the media play back system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media play back system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the play back queue for play back.

At step 650c, the control device 130a receives input corresponding to a command to play back the selected media content. In response to receiving the input corresponding to the command to play back the selected media content, the control device 130a transmits a message 651b to the play back device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the play back device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin play back of the selected media content in response to a message from the playback device 110a such that all of the devices in the group play back the selected media content in synchrony.

### IV. Wireless Power Transfer Devices and Associated Systems and Methods

Audio playback devices capable of receiving wireless power provide several distinct advantages over conventional wired devices. For example, there is no need to hide unsightly power cords by routing them through a wall or underneath furniture. Wireless power transfer may also allow a user to reposition devices more easily around a home or room without needing to disconnect or re-route power cords. To enable this functionality, one or more wireless power transmitter devices can be provided in the vicinity of an audio playback device having a wireless power receiver therein. Such a transmitter device can include another play back device (e.g., a soundbar, subwoofer, or any playback device having a wired power connection), or a non-play back device (e.g., a power hub that provides wireless power to the play back device without itself driving audio output). In some examples, one or more playback devices can include both a wireless power receiver and a wireless power transmitter, such that these devices may be used in either configuration, or in some instances may be used in both configurations simultaneously (e.g., as a “relay” in which a device receives wireless power from an external transmitter device and transmits wireless power to an external receiver device). In some instances, a plurality of such playback devices can transfer wireless power among one another in a mesh configuration, with the particular device-to-device transmission being selected to provide the desired power levels, device performance, and user experience.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to operate one or more components of the receiver device (e.g., to power at least one amplifier of a playback device). In various examples, a single playback device (or other device) can be both a wireless power transmitter and a wireless power receiver, while in other examples a particular device may be only a transmitter device or only a receiver device.

In various examples disclosed herein, such wireless power transfer can include mid- or long-range wireless power transfer. As used herein, mid- and long-range wireless power transfer includes wireless power transfer over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling).

a. Suitable Wireless Power Transfer Device Components

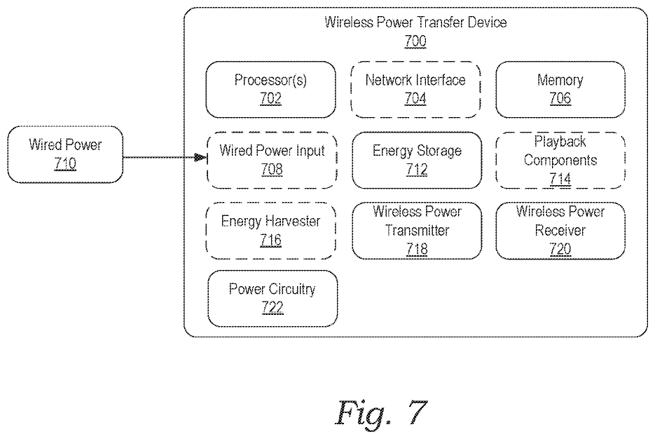

FIG. 7 is a schematic block diagram of a wireless power transfer (WPT) device 700. In some examples, the device 700 can be coupled to, integrated into, or included within a play back device (e.g., playback device 110a of FIG. 1C), an NMD (e.g., NMD 120a of FIG. 1F), or other suitable device.

Referring to FIG. 7, the WPT device 700 includes one or more processors 702, a network interface 704, and memory 706. These can be similar to, identical to, or include, processors 112a, network interface 112d, and memory 112b described above with respect to FIGS. 1C and 1F. In various examples, the wireless power transfer device 700 can include any or all of the features of playback device 110a or NMD 120a described previously herein. In some examples, the network interface 704 can include one or more transceivers that are configured to communicate via at least one WIFI network, and/or at least one BLUETOOTH network.

WPT device 700 optionally includes a wired power input port 708 that is configured to be electrically coupled to wired power 710 (e.g., via 110/220V wall power, a USB-C charger, etc.), such as an AC power port or a USB port (e.g., a USB TYPE-A port, a USB TYPE-B port, a USB TYPE-C port, etc.). The power input port 708 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 708 is omitted, and the WPT device 700 operates solely on the basis of power received wirelessly from external transmitter device(s) and/or energy generated via energy harvester(s) 716.

The WPT device 700 further includes an energy storage component 712, which can take the form of a rechargeable battery, a capacitor, a supercapacitor, or any other suitable component that can store energy. The energy storage component 712 can be configured to store energy and to facilitate operation of the device (e.g., powering one or more amplifiers of a playback device). In this regard, the energy storage component 712 can be a battery that has a chemistry that facilitates recharging the battery, such as lithium-ion (Li-ion), nickel-metal hydride (NiMH), nickel-cadmium (NiCd), etc. The battery can be sized such that the processor(s) 702 and other components of the WPT device 700 can operate on battery power alone for an extended amount of time without the battery needing to be recharged. For example, the battery can have a 20 watt-hours (Wh) capacity that facilitates continuous play back of audio for at least 4 hours on battery power alone. The battery can be charged using power from one or more other components in the device 700 (e.g., wired power input port 708, wireless power receiver 720, energy harvester 716, etc.).

As noted previously, in some examples, the wireless power device 700 can include audio playback components 714 (e.g., one or more transducers, audio processing circuitry, microphones, voice processing circuitry, etc.), and as such the WPT device 700 can include or be part of an audio playback device or a network microphone device as described elsewhere herein. In various examples, such an audio playback device can be a soundbar, a subwoofer, a headphone device, a hearable device, a portable audio playback device, an architectural playback device, or a video playback device

The WPT device 700 optionally includes one or more energy harvesters 716. Energy harvesters 716 may include those devices configured to derive power from energy sources in the environment (e.g., solar energy, thermal energy, wind energy, salinity gradients, kinetic energy, sound energy, etc.). For example, the energy harvesters 716 can include one or more photovoltaic cells configured to convert received light into a voltage. Any of a variety of energy harvesters 716 may be included in the WPT device 700. Examples of such energy harvesters include photovoltaic cells, thermoelectric generators, micro wind turbines, piezoelectric crystals, electroacoustic transducers, and kinetic energy harvesters.

The WPT device additionally includes a wireless power transmitter 718, a wireless power receiver 720, and power circuitry 722. In operation, the WPT device 700 can receive wireless power from an external transmitter device via the receiver 720, and can transmit wireless power to an external receiver device via the transmitter 718, with the power circuitry 722 controlling some or all of the functions associated with these operations.

The wireless power transmitter 718 can include any component or combination of components capable of transmitting wireless power to an external wireless power receiver device. Such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power transmitter 718 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from the wireless power transmitter 718). In various examples, the wireless power transmitter 718 in such instances can include an optical source such as a laser, a microwave source, an antenna (e.g., directional antennas, phased array antennas, etc.), or any other source of electromagnetic radiation. In some instances, the wireless power transmitter 718 can include one or more steering components configured to direct, focus, or steer wireless power. Such steering components can include, for example, one or more lenses, mirrors, directional antennas, or other suitable components.

Additionally or alternatively, the wireless power transmitter 718 can be configured to transmit wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power transmitter 718 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

The wireless power receiver 720 can include any component or structure configured to receive power wirelessly (e.g., via inductance, resonance, radiation, etc.) from an external wireless transmitter device. As noted previously, such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power receiver 720 can receive power via radiative techniques such as lasers, radio waves, microwaves, or other such techniques involving propagation of electromagnetic radiation from the transmitter device towards the receiver device. The wireless power receiver 720 in such instances can include an optical receiver such as a diode, a photovoltaic cell, an antenna (e.g., a rectenna), or other suitable hardware that can convert electromagnetic radiation into electrical energy.

Additionally or alternatively, the wireless power receiver 720 can be configured to receive wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power receiver 720 can include electrically conductive coils (e.g., in the case of inductive coupling), electrodes (e.g., in the case of capacitive coupling), a rotating armature carrying a magnets thereon (e.g., in the case of magnetodynamic coupling), or any other suitable structure capable of receiving power wirelessly via electromagnetic coupling.

With continued reference to FIG. 7, the WPT device 700 can include power circuitry 722 configured to receive power from the energy storage component 712, the wired power input 708, and/or the wireless power receiver 720, and, using the power obtained therefrom, drive an amplifier and/or a electroacoustic transducer with an audio output based on source audio. The power circuitry 722 can be configured to perform any of a variety of power-related tasks including, for example, one or more of the following: (1) power conversion (e.g., AC-AC conversion, AC-DC conversion, DC-AC conversion, and/or DC-DC conversion): (2) power regulation: (3) battery charging; and/or (4) power monitoring (e.g., battery monitoring). Examples of electrical components that may be integrated into the power circuitry 722 include transformers, rectifiers, inverters, converters, regulators, battery chargers, and/or power management integrated circuits (PMICs). In some examples, such power circuitry 722 can be integrated into either or both the wireless power transmitter 718 and the wireless power receiver 720

In some examples, the power circuitry 722 can include battery circuitry that facilitates monitoring a state of a battery. In these examples, the battery circuitry can identify battery state information that includes information regarding one or more of the following battery states: a state-of-charge (SoC), temperature, age, and/or internal impedance. The battery circuitry can communicate the battery state information to, for example, the processor 702.

The power circuitry 722 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, fly back, resonant, etc, switching regulator circuitry. The regulation circuitry can include one or more linear voltage regulators such as low-dropout (LDO) regulators. The regulation circuitry can be configured to output one or more fixed DC voltages (e.g., ±5V, ±12V) or AC voltages.

b. Wireless Power Group Examples

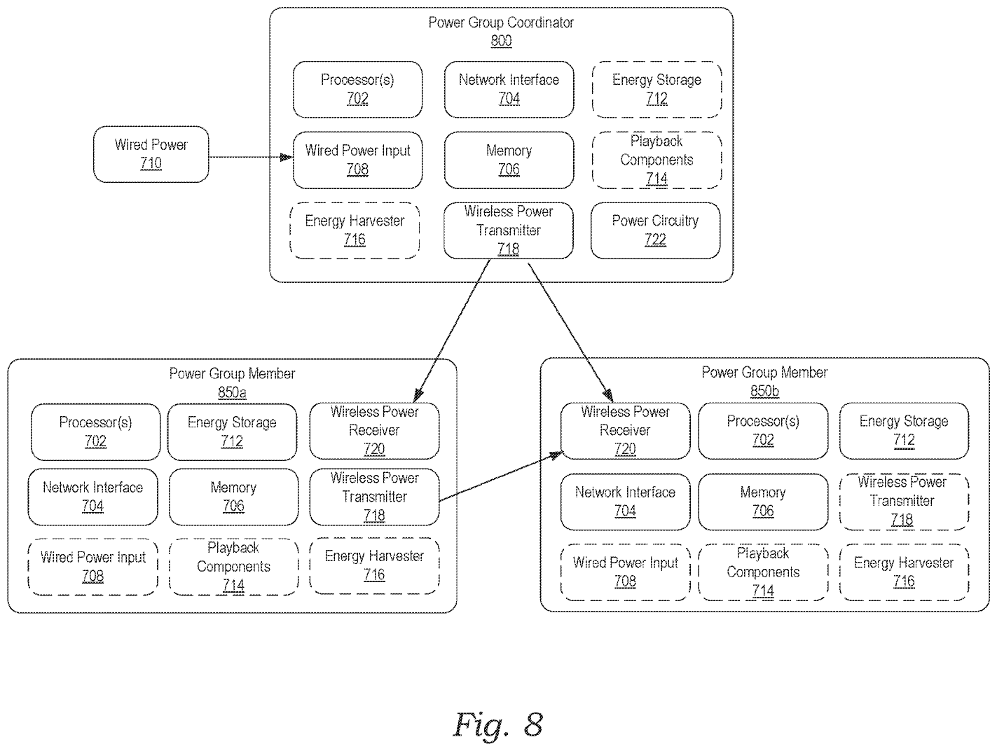

FIG. 8 shows interactions among a power group, which includes a plurality of WPT devices that can transfer power and/or data among one another. In the example shown in FIG. 8, the group includes a power group coordinator 800, and first and second power group members 850a and 850b. Each of the power group coordinator 800 and the power group members 850a and 850b can include some or all of the components described above with respect to the WPT device 700 of FIG. 7. In some examples, some or all of these devices can include or be audio playback devices. Although the illustrated group includes three devices, in various examples there may be one, two, four, five, or many more power group members (not shown).

As used herein, a “power group” can include two or more devices that are configured to wirelessly transfer power therebetween. In the illustrated example, the coordinator 800 transmits wireless power (e.g., via wireless power transmitter 718) to each of the first power group member 850a and the second power group member 850b. Additionally, the first group member 850a transmits wireless power to the second power group member 850b. In alternative examples, the power group coordinator 800 may transmit wireless power to fewer than all members of the wireless power group, with one or more group members 850 transmitting power to other group members 850 such that each device of the group receives or transmits wireless power to or from at least one other device of the group.

In the illustrated example, the power group coordinator 800 does not include a wireless power receiver 720, and it is connected to wired power 710. However, in other instances the power group coordinator 800 may have no connection to wired power 710, and may itself only be powered via wireless power transmission and/or energy harvesting. In some examples, one or more of the power group members 850 may be connected to wired power instead of or in addition to receiving wireless power from other group members.

As used herein, a “power group coordinator” can include a wireless power transfer device that is configured to transmit instructions to one or more power group members to initiate, cease, or modulate wireless power transmission therebetween. For example, a power group coordinator may cause the first power group member 850a to initiate wireless power transmission to the second power group member 850b. As described in more detail elsewhere herein, in some examples wireless power transmission may be initiated, ceased, or modified based on a number of parameters (e.g., a battery level of a device, a level or rate or wireless power received at a device, audio playback levels, etc.). In some examples, such parameters may be determined by or transmitted to the power group coordinator 800, which may then determine any appropriate modifications to wireless power transfer within the group, and may transmit instructions to group members accordingly.

In at least some instances, there may be no power coordinator. In such cases, each wireless power transfer device may independently determine whether, how, and when to transmit or receive wireless power from any external transmitter or receiver devices.

As noted previously, in some examples a plurality of audio playback devices can be grouped together for synchronous audio playback (e.g., as a bonded zone). In such instances, one of the playback devices may be a coordinator of the group, and may transmit and receive timing information from one or more other devices in the group. In various examples, the power group may be identical to the audio playback group. Alternatively, the power group may differ at least in part from any audio playback grouping. In at least some examples, the power group coordinator 800 may also serve as an audio playback group coordinator. In such cases, the power group coordinator 800 may transmit timing data or other information to group members via a wireless network and/or via data incorporated into the wireless power signals, as described in more detail elsewhere herein. Alternatively, the power group coordinator 800 and the audio playback group coordinator may be different devices. In still other examples, the power group may be formed without any audio playback grouping taking place, in which case there may be no audio playback group coordinator.

### V. Examples of Power-Based Audio Playback Management

As noted previously, play back devices having relatively thin form factors-including, for instance, mountable playback devices, can provide a number of advantages (e.g., more invisible to the user, more options for placement within a room) over playback devices having relatively thicker form factors. However, conventional power cords extending from such devices can detract from their benefits. Accordingly, it can be useful to provide mountable audio playback devices that either receive power wirelessly from adjacent devices and/or are coupled to a power source via a thin cable suitable for “trickle charging” the mountable playback devices, but which is less visually intrusive than conventional power cables. To ensure that the mountable playback device has adequate power for peak power output (e.g., high volume audio, bass-heavy audio, etc.), such mountable playback devices can include an onboard energy storage (e.g., rechargeable battery, capacitor, etc.).

As used herein, “mountable playback devices” include playback devices that are configured to be coupled to a wall, ceiling, or other mounting surface. Such devices may have an internal energy storage, such as a rechargeable battery, an ultracapacitor, etc., that allows the device to be operational even when not coupled to an external power source (e.g., a charging stand, a wire connected to a power outlet, etc.). Such mountable playback devices may also be portable, and throughout the specification a “portable playback device” can be substituted for a “mountable play back device,” In contrast, “stationary plug-in playback devices” may include play back devices that cannot operate without being coupled to an external power source (e.g., a power cord connected to a wall outlet, a power stand, etc.). Such devices are stationary in the sense that they typically remain in one place, but of course may be unplugged and moved about the environment from time to time. And as those of ordinary skill in the art will appreciate, in some instances, stationary devices may be, in fact, battery-powered devices that typically or always remain in one place that may receive power via a cable plugged into the device and/or via a charging base, dock, etc In various examples, mountable playback devices can take the form of relatively thin panels (e.g., having a smallest dimension of less than about 4 inches), although any suitable form factor can be employed. In some examples, such panels can be decorated with artwork or other designs to further obscure the playback device from view.

In some instances it can be useful to conserve power for wall-mountable audio playback devices, such as by offloading at least a portion of the audio content (e.g., some or all of the low-frequency audio content) to one or more nearby playback devices. This offloading may occur automatically based on certain power parameters or proximity parameters, or alternatively may occur when the user groups the mountable play back device with one or more other playback devices. In the case of automatic grouping, this may occur when the system detects that the mountable playback device is within a certain, predetermined vicinity of another play back device (whether another mountable playback device or a stationary plug-in playback device).

As described in more detail below; the particular schemes for modifying the audio output of the mountable playback device (e.g., offloading at least some audio playback responsibilities to another nearby playback device) can be based on acoustic characteristics of the devices, a energy storage level of the mountable playback device, the proximity of the devices (e.g., the devices are within a predetermined distance for at least a threshold amount of time), the acoustic efficiency profile of the various playback devices, or the current volume output of the nearby playback device (e.g., only offloading lower frequency outputs to the nearby playback device when that playback device is playing back audio loud enough that a user would not immediately notice the change). Such power-optimization schemes may also be based at least in part on the battery temperature of the mountable playback device, as the rate of power consumption may vary with temperature. Moreover, in addition to modifying the audio output, other functions of the mountable playback device can be modified or restricted based on power levels (e.g., disabling microphones, Bluetooth antenna, lights, etc.).

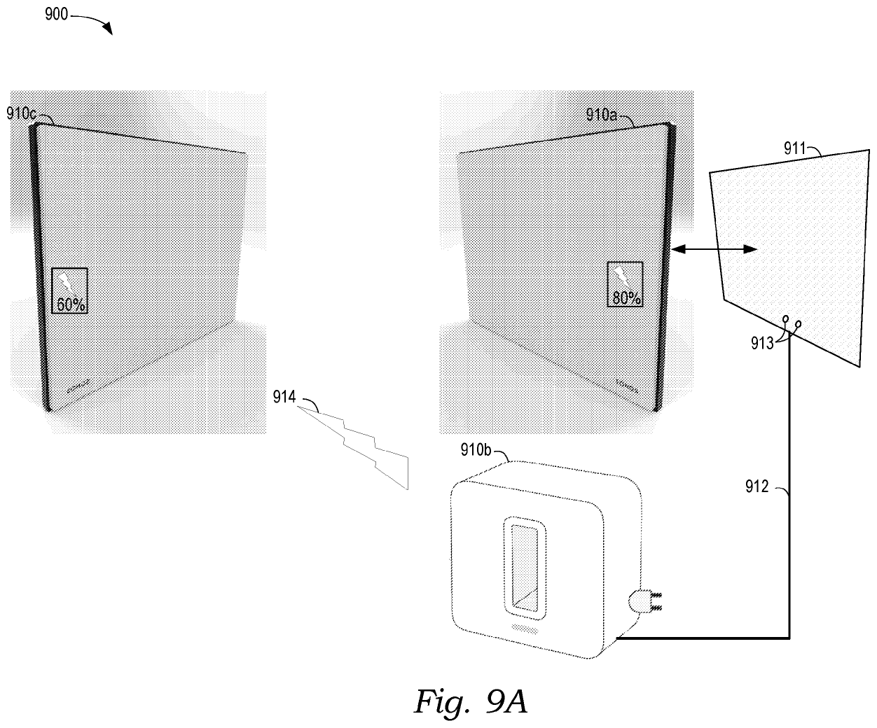

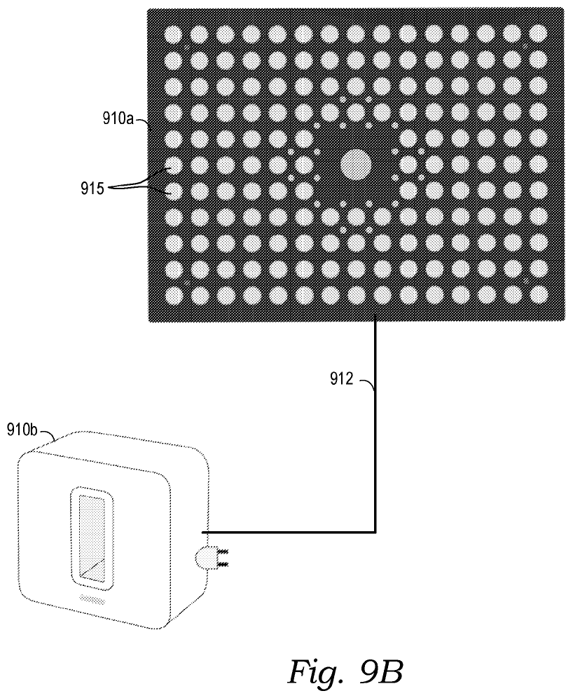

FIG. 9A is a schematic illustration of a media play back system 900 including a first mountable playback device 910a, a stationary plug-in playback device 910b, and a second mountable playback device 910c. The mountable playback device 910a can be removably coupled to a mountable frame 911, which can be secured to wall or other mounting surface. As illustrated, a physical cable 912 can extend between the stationary plug-in playback device 910b and the frame 911. When the mountable playback device 910a is coupled to the frame 911, electrical connection can be established (e.g., via electrical contacts 913 of the frame 911 and corresponding contacts of the mountable playback device 910a), thereby establishing an electrical connection between the mountable playback device 910a and the stationary plug-in playback device 910b. This physical connection can provide wired power transmission and/or wired data transmission between the two devices. Optionally, the mountable playback device 910a can be configured for use when not mounted to the frame 911, for example by being temporarily placed about the user's home at a desired location. When not mounted to the frame 911, the mountable play back device 910a can operate utilizing the onboard energy storage (e.g., battery, capacitor) and/or wireless power receipt.

In some instances, the physical cable 912 can be relatively thin (e.g., thinner than a conventional power cable for an audio playback device) so as to be less noticeable to a user. Such a thin physical cable 912 can be arranged as a low-voltage, low-current cable that is capable of providing power and/or data to the mountable play back device 910a. The physical cable 912 can take the form of printed conductive ink applied to a wall or other mounting surface, copper tape, a thin wire, or other such conductor. Optionally, this cable 912 is thin enough to be painted over to be substantially completely disguised from view. In some examples, the cable 912 can be configured to supply between about 30-50 watts of power.

FIG. 9B is a schematic illustration of a portion of the media play back system 900 of FIG. 9A, in which a cover of the mountable play back device 910a is omitted to illustrate a plurality of underlying transducers 915. Although the illustrated example shows a grid of circular transducers 915, the particular size, dimensions, and arrangement of the transducers 915 can vary according to the desired parameters of the playback device 910a. In some instances, the transducers 915 can be configured to be relatively thin so as to enable the overall low-profile aspect of the play back device 915.

As noted above, the physical cable 912 can provide power from the plug-in playback device 910b to the energy storage of the mountable playback device 910a. In some examples, this power delivery can serve as a “trickle charge” that is sufficient to slowly increase the power level of the energy storage of the mountable play back device 910a, though this power delivery may be insufficient to provide adequate power for full operation of the mountable play back device 910a. For example, when the mountable play back device 910a is playing back certain audio content (e.g., high volume, relatively high bass content, etc.), the power consumption may exceed the rate of power received via the physical cable 912. In such instances, the mountable play back device 910a can draw on its internal energy storage to supply the required power. If such relatively high-power operation continues for an extended period of time, the power level of the energy storage can be depleted. In extreme cases, the power level can be fully depleted until the mountable playback device 910a is no longer fully operational, and either shuts down altogether or is unable to provide the desired audio output.

The stationary plug-in playback device 910b can take the form of a subwoofer, soundbar, all-in-one speaker, or any other suitable audio playback device. In some implementations, the plug-in playback device 910b has greater bass-output capabilities than the mountable play back device 910a, while in other implementations the mountable play back device 910a has similar or greater bass-output capabilities compared to the plug-in play back device 910b. Although only the three playback devices 910a-910c are shown, in various examples there may be more or fewer playback devices. In particular, in some examples the stationary plug-in play back device 910b can itself serve as a satellite play back device to another primary playback device (e.g., a playback or other home theatre primary play back device).

In the illustrated example, while the stationary plug-in playback device 910b is coupled to the first mountable playback device 910a via a physical cable 912, the stationary plug-in playback device is coupled to the second mountable playback device 910c via a wireless connection 914. This wireless connection can provide wireless power transmission and/or wireless data transmission.

The first and second mountable play back devices 910a and 910c can each include a energy storage, which can take the form of a battery, capacitor, or other suitable structure that can store energy for use during audio playback or other operation of the devices. As described in more detail elsewhere herein, in some implementations either or both of the mountable playback devices 910a and 910c can include wireless power receivers (and/or transmitters). Additionally or alternatively, the mountable playback devices 910a and/or 910c can include energy harvesters (e.g., solar cells, thermal power generators, etc.).

As described above, the first and second mountable playback devices 910a and 910c can each comprise one or more audio transducers 915 for outputting sound (FIG. 9B). In some examples, the one or more transducers of each device can comprise an array of tweeters, such as the transducers 214a-c described above with respect to FIG. 2A. In some examples, the one or more transducers may comprise one or more midrange and/or woofer transducers such as, for instance, one or more of the transducers 214d-f described above with respect to FIG. 2A. In some examples, the one or more transducers may comprise one or more dual membrane transducers such as those described in U.S. Pat. No. 11,297,415, which is hereby incorporated by reference in its entirety. In certain examples, the one or more transducers comprise an array of ultrasound transducers whose operation results in at least a portion of the output being audible to a listener.

In operation, the media play back system 900 can coordinate play back responsibilities among the various playback devices 910a-910c. In some instances, this can include the stationary plug-in playback device 910b serving as a coordinator device that automatically forms a bonded zone with one or both of the mountable playback devices 910a-910c. As described in more detail elsewhere herein, this coordination can also involve assigning varying playback responsibilities to the particular devices depending on energy storage levels, device capabilities, and/or a number of other parameters. In addition to audio playback coordination, the plug-in play back device 910b (and/or any other suitable device) can serve as a power group coordinator device that manages power transmission and/or receipt among the various play back devices. For example, wireless power transmission from the plug-in playback device 910b to the second mountable playback device 910c can vary depending on the energy storage level of the mountable playback device 910c, the volume and content of the audio being played back, and/or any other suitable parameters (e.g., as energy storage level drops, the rate of wireless power transmission can increase, and vice versa).

In various examples, one or both of the mountable playback devices 910a and 910c can receive audio data (and/or other data) from the plug-in playback device 910b. In at least some examples, a mountable playback device may receive power from one plug-in play back device 910b while receiving audio data (and/or other data) from a different playback device (e.g., a soundbar or other home theatre primary). Moreover, one or both of the mountable playback devices 910a and 910c can receive wireless power from a different wireless transmitter device (e.g., another playback device or a standalone wireless power transmitter device). In some embodiments, power transmission and data transmission can be scheduled so as to be non-overlapping (e.g., ceasing wireless power transmission before initiating data transmission), for example to ameliorate problems relating to interference or other drawbacks. In at least some examples, wireless data and wireless power transmission can be contemporaneous. Additionally or alternatively, in some instances the stationary plug-in playback device 910b can perform certain audio processing operations before providing the audio data to the mountable playback device(s) 910a and/or 910b. For example, the stationary plug-in playback device 910b can perform array processing, and can transmit individual delays associated with particular audio transducers to the mountable playback device(s) 910a and/or 910b. This pre-processing can advantageously reduce the power consumption of the mountable playback device(s) 910a and/or 910b.

With reference to FIG. 9A, in various examples the media playback system 900 can vary the playback responsibilities of some or all of the play back devices 910a, 910b, and 910c depending on the particular conditions of the system 900 or the particular devices 910a-910c. In some instances, audio content can be played back via the first mountable playback device 910a while in a first operating mode. This can represent the “normal” operating mode of the first mountable playback device 910a, in which the device operates without any constraints due to energy storage levels. Under certain conditions, the media play back system 900 can transition between the first operating mode to a second operating mode in which at least a portion of the audio content that would otherwise have been played back by the first mountable playback device 910a is offloaded to one or more of the other playback devices 910b-910c. Whether and how such audio content is offloaded to one or more other play back devices can depend on a power parameter, a proximity parameter, a grouping parameter, the particular audio content being played back, or any other suitable parameter. For example, the power parameter can include or relate to the energy storage level (e.g., battery charge level) of the first mountable playback device 910a and/or the other devices, the acoustic efficiency profile of the various playback devices, a battery health parameter (e.g., power capability, internal resistance of the energy storage unit, total charge cycles utilized or remaining, etc.), the battery temperature of the first mountable playback device 910a or other devices, or a rate of power consumption of the first mountable playback device 910a or the other portable playback devices. In some instances, a power parameter can relate to a level or rate or power generation (e.g., via on-board energy harvesters) or wireless power receipt (e.g., from a wireless power transmission device as described elsewhere herein). The proximity parameter can include or relate to a proximity between the first mountable playback device 910a and any of the other play back devices, optionally including a determination that particular devices are within a predetermined vicinity of one another for a predetermined threshold amount of time. The grouping parameter can include or relate to whether or not the first mountable play back device 910a has been grouped with any other playback devices for synchronous playback.

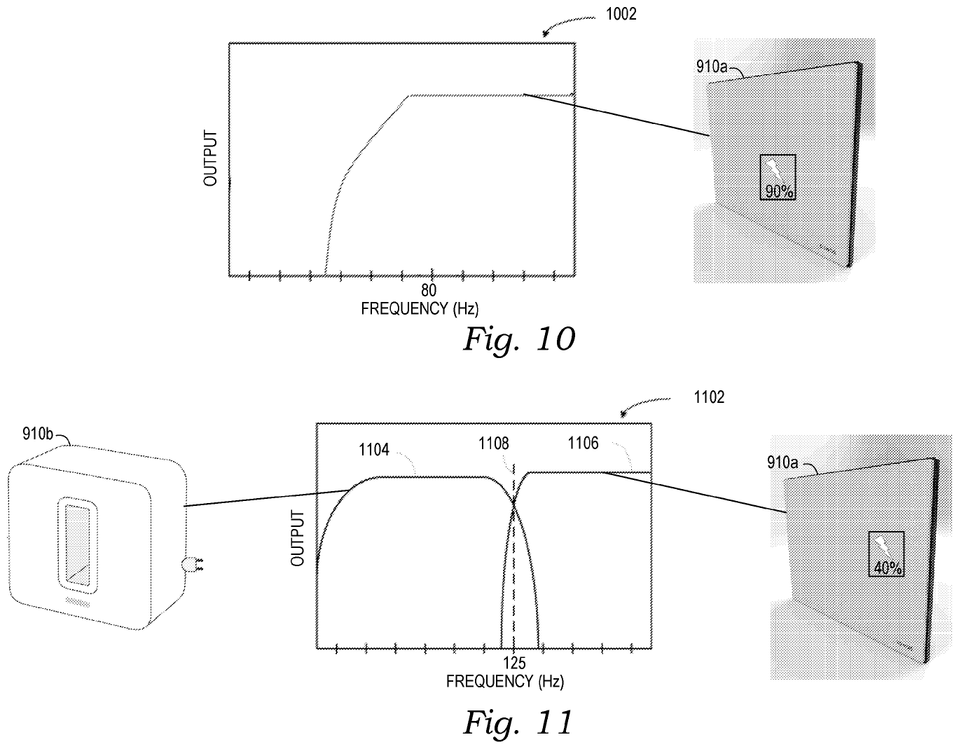

FIG. 10 illustrates example frequency response curve 1002 for a mountable playback device 910a operating in a first mode. In this configuration, the mountable play back device 910a can have substantially full-frequency play back responsibilities. This can represent the “normal” operating mode of the mountable playback device 910a, when the power level is sufficiently high (e.g., 90% of charge, as shown here). As noted previously, as the power level of the mountable playback device 910a falls, it can be useful to transition the mountable play back device 910a from a first mode to a second mode. In some instances, while in the first mode, the mountable playback device 910a assumes substantially full-frequency play back responsibilities, and while in the second mode, the mountable playback device 910a assumes different playback responsibilities (e.g, offloading at least some low-frequency audio content to one or more nearby playback devices).

FIG. 11 illustrates example frequency response curves 1102 for a mountable playback device 910a and a stationary plug-in playback device 910b operating in a second mode. Although this example relates to a mountable playback device 910a that is disconnected from power and a stationary plug-in playback device 910b that is connected to power, this approach can be extended to scenarios in which the stationary plug-in playback device 910b is replaced with a portable playback device that is connected to power (e.g., via a charging base, charging cradle, charging cable, etc.).

While in the second mode, the frequency response 1104 corresponds to the audio output of the stationary plug-in playback device 910b, and the frequency response 1106 corresponds to the audio output of the mountable playback device 910a. In the example illustrated in FIG. 11, a crossover or threshold frequency 1108 is approximately 125 Hz, though any suitable threshold frequency can be used. As shown, the frequency response 1104 of the stationary plug-in play back device 910b is primarily below the threshold frequency 1108, and the frequency response 1106 of the mountable play back device 910a is primarily above the threshold frequency 1108.

In the illustrated example, the stationary plug-in playback device 910b outputs audio with more bass-heavy content (e.g., higher output below the threshold frequency 1108) than the audio output by the mountable playback device 910a (which has a higher output above the threshold frequency 1108). Because bass-heavy audio content can consume more power during playback than higher frequency audio content, offloading bass-heavy audio content to the stationary plug-in play back device 910b can significantly decrease the power consumption of the mountable playback device 910a. Although the threshold frequency 1108 in this example is about 125 Hz, in various examples the threshold frequency can be about 40, 50, 60, 70, 80, 90, 100, 110, 120, 130, 140, 150, 160, 170, 180, 190, 200, 210, 220, 230, 240, 250, 300, 350, 400, 450, or 500 Hz. In some examples, the threshold frequency can vary over time based on a power parameter, a proximity parameter, and/or any other suitable parameter

According to some examples, while in the second mode the stationary plug-in playback device 910b may play back only audio content below the predetermined threshold frequency. This may be particularly useful in masking the fact that the stationary plug-in playback device 910b is augmenting audio that is being played back via the mountable playback device 910a. Because bass content is more omnidirectional than higher frequency audio content, bass content provided by a nearby but still separately located stationary plug-in playback device 910b may not be consciously detectable by the user listening to audio via the mountable playback device 910a.

In some examples, in transitioning to the second mode, the mountable play back device 910a can be automatically grouped or bonded with the stationary plug-in playback device 910b for synchronous play back. This automatic grouping or bonding can be visible to the user (e.g., indicated via a user interface on a controller device) or invisible to the user (e.g., not indicated via the user interface on a controller device).

Although this example illustrates a relatively simple cross-over configuration, in which the stationary plug-in playback device 910b outputs audio primarily below the threshold frequency 1108 and the mountable playback device 910a outputs audio primarily above the threshold frequency 1108, other approaches are possible. For example, the particular spectral calibration profile of the mountable playback device 910a and/or of the stationary plug-in playback device 910b can vary between the first mode and the second mode. Moreover, the particular spectral calibration profile adopted by the mountable playback device 910a can vary depending on the particular playback device that is being used to augment its output in the second mode. For instance, if the stationary plug-in playback device 910b has very high bass-output capabilities, the mountable playback device 910a may adopt a particular spectral calibration profile while in the second mode (e.g., offloading substantially all bass output responsibilities). However, if the stationary plug-in play back device 910b were instead a device with a smaller form factor and lower bass-output capabilities, the mountable playback device 910a may adopt a different spectral calibration profile while in the second mode (e.g., offloading a smaller proportion of the bass output responsibilities to the nearby stationary plug-in playback device).

In certain instances, the stationary plug-in play back device 910b may output audio content in a first frequency range a predetermined percentage (e.g., 10%, 20%, 30%, 40%, 50%) greater than the threshold frequency 1108. Using this approach can further reduce an amount of power consumed by the mountable play back device 910a during audio output, even if the first frequency range is outside the typical operating parameters of the stationary plug-in playback device 910b. Consider a scenario in which the stationary plug-in playback device 910b comprises a subwoofer that typically operates at or below 100 Hz. In an effort to conserve power consumed by the mountable play back device, the subwoofer may output audio up to 120 Hz (i.e., 20% greater than the threshold frequency 1108) even if the output 120 Hz is outside of the subwoofer's typical operating range. If, for example, the subwoofer is later bonded to another plug-in device (e.g., a soundbar or other plug-in playback device), it may revert to outputting audio only less than or equal to the threshold frequency 1108

In some instances, while in the second mode, the mountable playback device 910a may continue to output some audio below the threshold frequency, although at a lower level than while operating in the first mode. Moreover, the threshold frequency itself may vary dynamically depending on a variety of factors, including the proximity of the two devices, the power level of the mountable play back device 910a, the acoustic efficiency of both play back devices, the temperature of the battery, etc.

Optionally, the play back responsibilities of the stationary plug-in playback device 910b can vary as the proximity of the two devices changes. For example, as the mountable play back device 910a is moved further away from the stationary plug-in play back device 910b, the audio output via the stationary plug-in playback device 910b can fade out, rather than abruptly terminating once a predetermined threshold distance is exceeded.

As noted above, the mountable play back device 910a can transition between the first mode and the second mode based at least in part on one or more power parameters or other suitable parameters. In various examples, the power parameter(s) can include a energy storage level of the mountable play back device 910a. For example, if the energy storage level falls below a predetermined first threshold, the mountable play back device 910a can transition from the first mode to the second mode. If the mountable playback device 910a is then re-charged, the mountable playback device 910a may transition from the second mode back to the first mode in response to the power level of the mountable playback device 910a rising above a predetermined second threshold. These thresholds can be the same (e.g., both transitions occur at 20% charge), or may differ (e.g., transition to second mode when energy storage falls below 20%, but transition back to first mode only when energy storage rises above 60%). Either or both threshold energy storages can be, for example, about 5%, 10%, 15%, 20%, 25%, 30%, 35%, 40%, 45%, 50%, 55%, 60%, 65%, 70%, 75%, 80%, 85%, 90%, or 95% of the full charge capacity of the portable playback device energy storage.

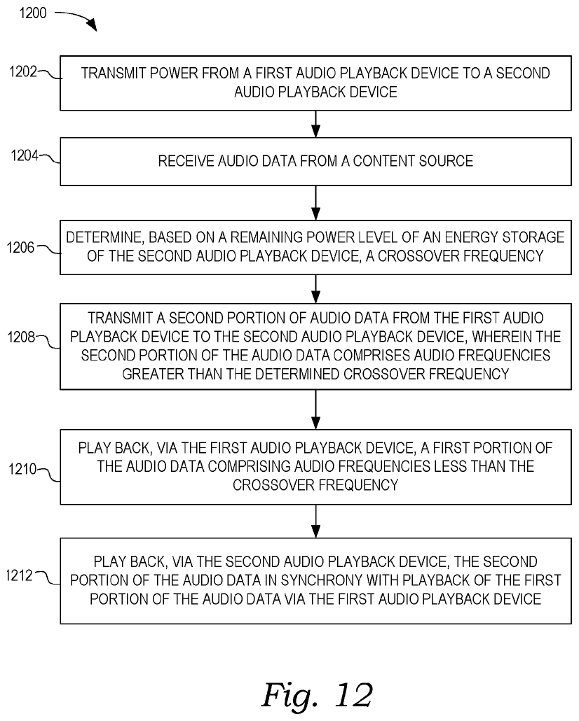

FIG. 12 illustrates an example method for power-based audio playback management in accordance with the present technology. The method 1200 can be implemented by any of the devices described herein, or any other devices now known or later developed. Various embodiments of the method 1200 includes one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

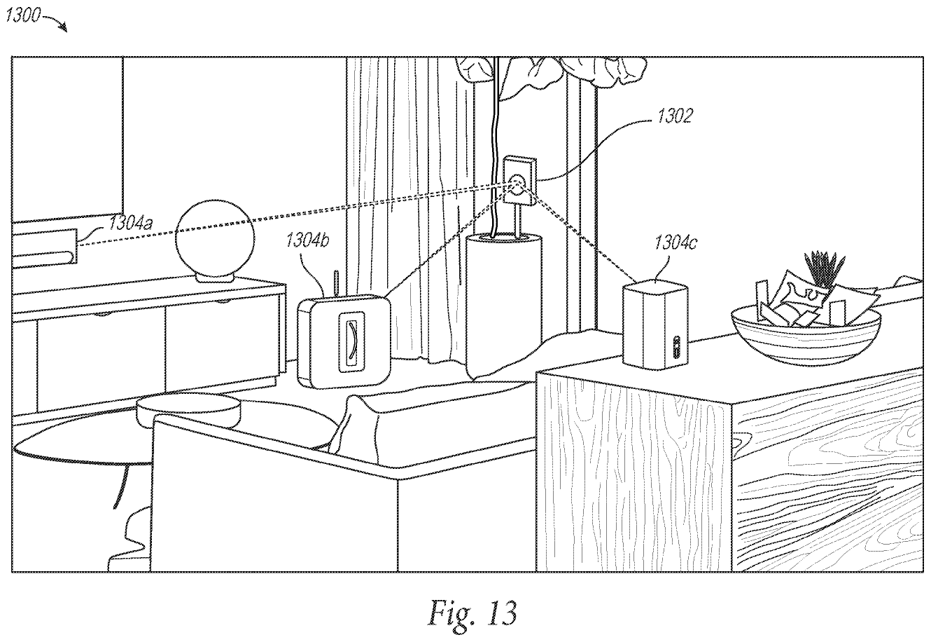

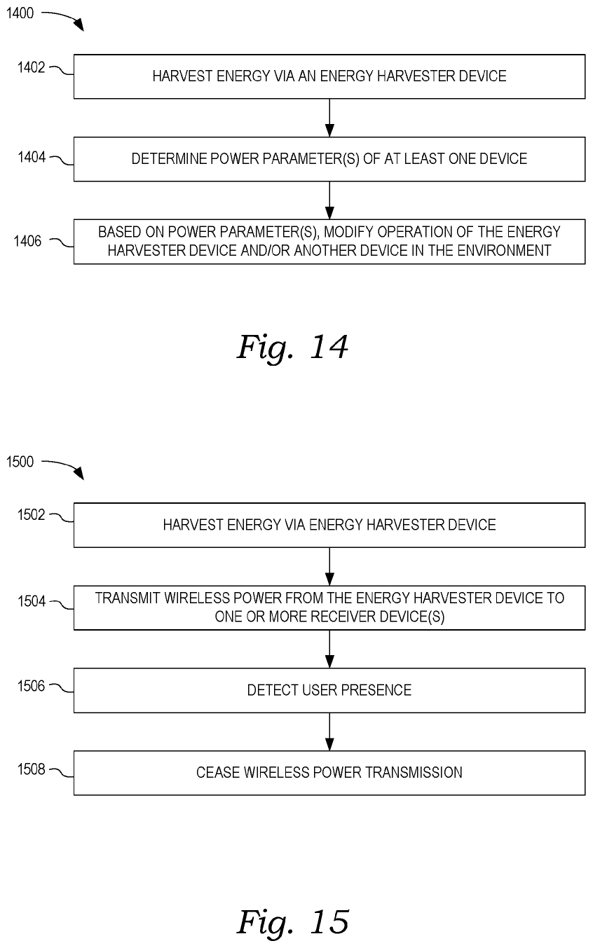

In addition, for the method 1200 and for other processes and methods disclosed herein, the flowcharts show functionality and operation of possible implementations of some embodiments. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 13 and 14 may represent circuitry that is wired to perform the specific logical functions in the process.

The method 1200 begins at block 1202, which involves transmitting power from a first audio playback device to a second audio playback device. The first audio playback device can be, for example, a plugged-in playback device, and may operate as a primary playback device. In some instances, the first audio playback device can have significant bass-output capabilities, for example a subwoofer, soundbar, or other suitable device. The second audio playback device can be a mountable play back device and/or a portable playback device, and can include a energy storage (e.g., a battery, a capacitor, etc.). Power transmission from the first audio playback device to the second audio playback device can be achieved via wireless transmission, wired transmission (e.g., via a physical cable linking the two devices), or some combination thereof.

At block 1204, the method 1200 involves receiving audio data from a content source. Depending on the configuration of the media play back system, the audio data can be received via one or both of the first or second audio playback devices, via a wired or wireless network connection, or alternatively via a physical line-in at one or both of the play back devices.

The method 1200 proceeds to block 1206 with determining, based on a remaining power level of a energy storage of the second audio playback device, a crossover frequency. This crossover frequency can be used to obtain first and second portions of the audio data, in which the first portion includes substantially or exclusively frequencies above the crossover frequency, and the second portion includes substantially or exclusively frequencies below the crossover frequency. In various examples, the particular crossover frequency can vary depending on one or more parameters. Among examples, the crossover frequency can be about 40, 50, 60, 70, 80, 90, 100, 110, 120, 130, 140, 150, 160, 170, 180, 190, 200, 250, 300, 350, 450, or 500 Hz, although other particular frequency values are possible. In some examples, the crossover frequency may vary over time.

At block 1208, the method involves transmitting the second portion of audio data from the first audio playback device (e.g., a plugged-in subwoofer) to the second audio playback device (e.g., a mountable playback device). As noted above, this second portion of audio data can include frequencies greater than the determined crossover frequency. This audio data can be transmitted directly from the first playback device to the second audio playback device (e.g., wirelessly via a network interface or via a wired connection such as physical cable 912 (FIG. 9A)), or alternatively can be provided to the second audio playback device from another play back device or other network device.

At block 1210, the first play back device (e.g., a plugged-in subwoofer) plays back the first portion of the audio data, which includes frequencies substantially or exclusively less than the crossover frequency. At block 1212, the second audio playback device (e.g., a mountable or portable playback device) plays back the second portion of the audio data in synchrony with the playback of the first portion of the audio data via the first playback device. In this configuration, a mountable or portable playback device can offload certain low-frequency playback responsibilities to a stationary plugged-in playback device, which can prolong the total available playback time of the mountable or portable playback device while also improving the overall acoustic performance. This arrangement can be particularly useful in masking the fact that the stationary plug-in playback device is augmenting playback via the mountable playback device. Additionally, because bass content is more omnidirectional than higher frequency audio content, bass content provided by a nearby but still separately located stationary plug-in playback device may not be noticeable to the user listening to audio via the mountable play back device.

In some instances, additionally or alternatively to varying the crossover frequency, the particular spectral calibration profile of the mountable playback device can vary. The particular spectral calibration of the mountable playback device may depend at least in part on the acoustic profile of the stationary plug-in playback device. For example, if the stationary plug-in play back device is highly equipped to output bass-heavy content (e.g., the stationary plug-in play back device is a dedicated subwoofer or device equipped with a woofer), then the mountable play back device may adopt a spectral calibration profile that outputs little or no low-frequency content. Conversely, if the stationary plug-in playback device is less well equipped to output bass-heavy content (e.g., the stationary plug-in playback device is a smaller device with less low-frequency output capability), then the mountable playback device may adopt a spectral calibration profile that still outputs some low-frequency content, although optionally still a lesser amount of low-frequency output than while in the first mode.

As noted above, the particular play back responsibilities assigned to the mountable playback device can depend on one or more or of: a power parameter, a proximity parameter, a grouping parameter, volume of playback, a temperature parameter, or any other relevant parameter or characteristic. The proximity parameter can include or be based on a determined distance between the mountable playback device and other playback device(s) within the environment, whether mountable playback devices, portable unplugged devices, portable plugged-in devices, stationary plug-in devices, or otherwise. For example, the proximity parameter can include an indication that another playback device is within a predetermined distance of the mountable playback device. Additionally or alternatively, this proximity determination can indicate that the other play back device is within a predetermined distance of the mountable playback device for at least a predetermined threshold amount of time. This approach can avoid undesirable transitions while the mountable playback device is being moved and is only temporarily in close proximity to another playback device.

In some instances, a volume of playback of the second portion of the audio content via the stationary plug-in playback device can depend at least in part on the proximity parameter. For example, if the devices are very near to one another, the stationary plug-in playback device may play back the second portion of the audio content at a lower volume than if the devices are further apart.

As noted above, in various examples, the indication that one or more other playback devices are in proximity to the mountable playback device can be based on one or more localization signals exchanged between the portable play back device and the other playback device(s), and/or localization signals between these devices and other network devices within the environment (e.g., a controller device, other playback devices, etc.). Additional details and examples of determining relative positions of play back devices within an environment can be found in commonly owned U.S. Application No. 62/261,876, filed Sep. 30, 2021, titled “Spatial Mapping of Media Playback System Components,” which is hereby incorporated by reference in its entirety and included as an Appendix to this application.

In some instances, the mountable play back device can be automatically grouped with another playback device for synchronous playback based on the proximity parameter. Optionally, such grouping can be performed without visible presentation to the user (e.g., the group may not be presented to the user via an interface via controller device or otherwise). In this manner, the user may not be aware that the mountable playback device has transitioned to the second mode. In other instances, such grouping may be visible to the user (e.g., presented to the user via an interface via controller device or otherwise).

The power parameter can include a energy storage level of the mountable playback device energy storage, a power consumption rate of the mountable playback device, an output volume level of the mountable playback device and/or other playback devices, an acoustic efficiency profile of the portable playback device and/or the stationary playback device, or a temperature associated with the portable playback device storage. In some instances, the mountable playback device can offload more low-frequency content when the power level drops below a predetermined threshold level, or a rate of power consumption rises above a predetermined threshold rate. Additionally, the acoustic efficiency profile of the mountable playback device may determine, at least in part, the crossover frequency. The acoustic efficiency profile may depend both on the particular features of a play back device (e.g., number and type of transducers), and the power consumption may be a function of the particular audio content being played back, the acoustic efficiency profile, and the play back volume.

The temperature associated with the mountable playback device storage can be obtained via an on-board temperature sensor or other suitable approach. In some instances, the temperature of the energy storage can affect the rate of power consumption. Moreover, excessively high temperatures may damage the energy storage or other components of the device, and as such temperatures above a predetermined threshold may cause the mountable playback device to offload more low-frequency content in order to reduce the temperature associated with the mountable playback device storage. Among examples, this transition can be responsive to the temperature associated with the mountable playback device energy storage rising above a predetermined first threshold, and the device may transition in the opposite direction (e.g., offloading less low-frequency audio content) when the temperature associated with the mountable playback device energy storage falls below a predetermined threshold. These thresholds can be the same (e.g., both transitions occur at 50 degrees Celsius), or may differ (e.g., begin offloading more low-frequency audio content when the temperature exceeds 50 degrees Celsius, but begin offloading less low-frequency content only when the temperature falls below 40 degrees Celsius). Either or both threshold temperatures can be, for example, about 5, 10, 15, 20, 25, 30, 35, 40, 45, 50, 55, 60, 65, 70, 75, or 80 degrees Celsius.

In some examples, the crossover frequency can be varied in response to the power level of the mountable playback device energy storage falling below a predetermined first threshold or rising above a predetermined second threshold. These thresholds can be the same (e.g., both transitions occur at 20% charge), or may differ (e.g., transition to offload more low-frequency content when energy storage falls below 20%, but transition back to offloading less low-frequency content only when energy storage rises above 60%). Either or both threshold energy storages can be, for example, about 5%, 10%, 15%, 20%, 25%, 30%, 35%, 40%, 45%, 50%, 55%, 60%, 65%, 70%, 75%, 80%, 85%, 90%, or 95% of the full charge capacity of the mountable play back device energy storage.

In some examples, the crossover frequency can be varied in response to the state of health (e.g., power capability) of the energy storage of the mountable playback falling below a predetermined first threshold or rising above a predetermined second threshold. These thresholds can be the same (e.g., both transitions occur at 80% state of health/30 mΩ internal resistance of the energy storage device), or may differ from one another.

The grouping parameter can include, for example, an indication that the mountable playback device is grouped with another playback device for synchronous playback (e.g., another mountable playback device, a stationary plug-in playback device, another portable playback device (whether plugged in or unplugged), etc.).

### VI. Example Energy Harvesting and Distribution for Audio Playback Devices

As noted previously, playback devices, wireless power transfer (WPT) devices, or other suitable devices can include energy harvesting components. Such devices are referred to herein as “energy harvester devices,” which can include any device that is configured to obtain or derive ambient energy from the environment rather than or in addition to obtaining electrical power from the power grid, a battery, or another electronic device. Such energy harvester devices can take the form of dedicated energy harvester devices (e.g., a special purpose device for obtaining and distributing power from environmental sources), audio playback devices equipped with energy harvesting capabilities, architectural features (e.g., windows, blinds, shades, curtains, planters, lights, etc.) equipped with energy harvesting capabilities, or any other suitable type of device or form factor.

Energy harvesting is the process of collecting and converting ambient energy sources, such as solar energy, thermal energy, wind energy, kinetic energy, or others, into electrical energy that can be used by small electronic devices (e.g., wireless devices). Energy harvester devices can provide a sustainable and low-cost alternative to the use of grid power or large batteries for powering various applications. In various examples, energy harvester devices can be configured to harvest solar energy, thermal energy, wind energy, salinity gradients, kinetic energy, sound energy, or any other suitable ambient energy from the environment. Examples of such energy harvesters include photovoltaic cells, thermoelectric generators, micro wind turbines, piezoelectric crystals, electroacoustic transducers, and kinetic energy harvesters.

By incorporating one or more energy harvester devices into a media play back system, for example, the overall use of grid electrical power can be reduced. In some instances, the use of stored battery power may also be reduced, thereby extending the life of existing batteries and lowering the overall demands of battery sizes for a given level of device performance.

In some implementations, an energy harvester device can transmit power to other devices within the environment (e.g., other devices within a media play back system, within the user's home or office, etc.). Such power transmission can take the form of wireless power transmission or wired power transmission via a physical wired connection between devices. Wireless power transmission may be particularly beneficial, as it eliminates the need for wires or cables that may be inconvenient, unattractive, or hazardous. In various examples, wireless power transmission can be achieved by using electromagnetic induction, electromagnetic radiation, or any other suitable method for wirelessly transmitting power between devices.

In the case of media play back systems including one or more playback devices, the use of energy harvester devices can improve the efficiency of the system, reducing the overall demand for electrical grid power, extending battery life, and/or reducing the requirements for battery capacity. In a typical media play back system, play back devices are in an idle state for the majority of the day (e.g., 85% or about 20 hours per day). In this idle state, the play back devices play back no media content, but may nonetheless consume a non-negligible amount of electrical energy to perform background tasks, such as capturing and processing microphone sound data for voice assistant service activation words and communicating state information to other devices in the media play back system. In certain examples, the background tasks may include tasks related to security of the device and/or user privacy.

In some examples, each of the playback devices can be limited to the use of grid power (i.e., power received via a power cord or plug-in charger) while that playback device is in an active state. During periods in which the play back device is in an idle state, the playback device may instead rely on harvested energy (e.g., energy derived from its own energy harvesting components (e.g., an integrated solar panel) or energy derived from a discrete energy harvester device which is then transmitted (via wired or wireless connection) to the playback device. For instance, relatively compact solar panels with sufficient exposure to the sun may generate enough energy (e.g., 2 watts or less) to continuously power an idle play back device. However, playback devices are often positioned within environments at locations that are not ideal for energy harvesting (e.g., at a location far away from windows or other light sources in the case of solar panels). Instead, users typically position playback devices around the environment based on performance in audio playback, user convenience, aesthetic preferences, or other considerations. Accordingly, a given playback device equipped with energy harvesting components may only be able to reliably obtain a fraction of the requisite power for idle state operation based on harvesting ambient energy from the environment.

To accommodate playback devices that may be placed at non-ideal positions for energy harvesting, it can be beneficial to position one or more energy harvester devices at locations that are particularly suited to extracting ambient energy from the environment (e.g., a position near a sunny window in the case of solar panels, a position outside in the case of wind-based energy harvesters, etc.). The energy harvester device can also be configured to deliver energy to one or more external playback devices (or other electronic devices) within the environment. As noted previously, such transmission can be wireless or via a wired connection. This can enable a user to position the receiver devices at desired locations around the environment even if those locations are non-ideal for harvesting energy. Accordingly, one or more energy harvester devices can capture ambient energy from the environment and distribute energy to other playback devices within the environment for use as needed. This way, the energy harvester device can provide a continuous and convenient power supply for other devices without requiring physical contact or alignment. In some implementations, the energy harvester device can include an inverter or other suitable components configured to feed harvested energy back into facility power (e.g., household grid). This supplied energy may compensate for the idle power of other devices connected to the same facility power, such that the overall power consumption is reduced or is even net 0 or less.

In some implementations, the media playback system (or some component thereof) can modify operation of one or more devices depending on the amount of energy harvested via the energy harvester device, the amount of energy consumed via one or more devices, the current, scheduled, or predicted states of the various devices (e.g., active or idle), or various other factors.

FIG. 13 illustrates an example system 1300 in which an energy harvester device 1302 captures ambient energy from the environment. The energy harvester device can include some or all of the components of the wireless power transfer device 700, power group coordinator 800, or power group member 850 devices described elsewhere herein. In the illustrated example, the energy harvester device 1302 is equipped with photovoltaic cells or other features to capture energy from ambient light (e.g., from the sun or artificial light sources). However, in various implementations, the energy harvester 1302 can include any one or more of the energy harvesting components or modalities described herein. For instance, in some examples, the energy harvester device 1302 may be configured to capture energy via at least one of: electromagnetic energy harvesting (e.g., solar, radio frequency (RF), induction, etc.), mechanical energy harvesting (e.g., piezoelectric, vibration, torsion, etc.) and thermodynamic energy harvesting (e.g., heat, chemical reaction, etc.), etc.

In various implementations, the energy harvester device 1302 may include one or more photovoltaic cells that convert solar radiation into electric current: one or more thermoelectric generators that convert temperature differences into electric voltage: one or more electrochemical cells that exploit salinity gradients between saltwater and freshwater: or one or more wind turbines, electroacoustic transducers, or piezoelectric crystals that convert mechanical motion into electric power.

The energy harvester device 1302 can additionally include an energy storage component such as a battery, a capacitor or ultracapacitor, or any other suitable mechanism for storing energy harvested from the ambient environment, drawn from grid power, received from external transmitter devices, or from any other source. The energy harvester device 1302 can also include additional electronic components, such as one or more processing components, a network interface (e.g., for wired or wireless network communication), user interface components (e.g., touch input, indicator lights), or any other features of the playback devices or wireless power transfer devices described elsewhere herein.

The energy harvester device 1302 can be configured to wirelessly transmit power to one or more external receiver devices 1304a-c (collectively “devices 1304”) which may be arranged at various locations within the surrounding environment (e.g., within the same room, household, or business, as part of the same media playback system, etc.). These external devices 1304 may likewise include some or all of the components of the wireless power transfer device 700, power group coordinator 800, or power group member 850 described elsewhere herein. In some examples, the energy harvester device 1302 can be configured to wirelessly transmit power to the external devices 1304 via one or more of: infrared electromagnetic transmission, WiFi transmission, radiofrequency (RF) transmission, magnetic resonance, or any other suitable wireless power transmission technique. The particular wireless power method can be selected based on the desired performance characteristics, costs, safety, and other factors, as the different approaches offer different trade-offs between power efficiency, range, directionality, safety, and interference.

In some examples, the energy harvester device 1302 can wirelessly transmit power to the external receiver devices 1304 over a distance of greater than about 10 cm (about 4 inches), 50 cm (about 20 inches), or 1 m (about 3 feet). This may enable wireless charging of external audio playback devices without requiring physical contact or close proximity with the energy harvester device 1302. Additionally or alternatively, the energy harvester device 1302 can be connected, either directly or indirectly, to one or more of the external devices 1304 via a physical link such as a wire or charging cable. In such instances, energy can be transferred from the energy harvester device 1302 to the external device(s) 1304 via the physical link instead of or in addition to wireless energy transfer.

Some or all of devices 1302 and 1304 can take the form of audio playback devices, for instance having one or more amplifiers, audio transducers, and/or other components to facilitate audio playback. Optionally, some or all of the devices 1302 and 1304 can include one or more microphone(s) configured to capture sound data in the environment, and associated electronics to process captured sound data (e.g., to capture user voice input and detect wake words, user commands, or other such user input). Additionally or alternatively, some or all of the devices 1302 and 1304 may not be audio playback devices (e.g., serving as dedicated energy harvester devices, wireless power relay devices, and/or other electronic devices besides audio play back devices).

In some implementations, the energy harvester device 1302 also includes a wireless power receiver configured to receive power wirelessly from one or more external transmitter devices within the environment (e.g., from another energy harvester device 1302, from one of the external devices 1304, etc.). The wireless power receiver may provide an alternative or supplementary source of power for the energy harvester device 1302.

In some implementations, some or all of the external devices 1304 which receive wireless power from the energy harvester device 1302 may also be equipped with wireless power transmitters, and as such these devices 1304 may further transmit wireless power to others of the external devices 1304 as needed. This may be useful when, for example, a given external device 1304 is too far from the energy harvester device 1302 or there is an obstruction between the energy harvester device 1302 and the external device 1304. In such instances, an intervening extemal device 1304 may receive wireless power from the energy harvester device 1302 and transmit wireless power to the more remote external device 1304, thereby “relaying” wireless power from the energy harvester device 1302 to the more remote external device 1304.

In some instances, the energy harvester device 1302 can include or take the form of an architectural device or structure, such as a window, blinds, shades, curtains, planters, light fixtures, or any other structure that serves both an architectural function and is also equipped with energy harvesting and/or wireless power transfer functionality. Such architectural features may also include associated electronics, including an energy storage component, network interface, processing components, etc.

Although the illustrated example depicts a single energy harvester device 1302 and multiple external devices 1304, in various implementations there may be any number of energy harvester devices 1302 and/or any number of external devices 1304. For instance, there may be multiple energy harvester devices 1302 that each provide wireless power to the same external device(s) 1304.

The energy harvester device 1302 may further be configured to determine, obtain, or receive a power parameter that characterizes one or more aspects of the energy harvester device 1302 itself, one or more of the external devices 1304, and/or the overall system 1300. Based on the power parameter(s), operation of one or more of the devices 1302 or 1304 can be modified, for example to improve the performance or efficiency of the system 1300, as described in more detail elsewhere herein.

FIGS. 14-14 illustrate example methods in accordance with the present technology. The methods 1400, 1500, 1600, and 1700 can be implemented by any of the devices described herein, or any other devices now known or later developed. Various embodiments of the methods 1400, 1500, 1600, and 1700 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 1400, 1500, 1600, and 1700 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 14-17 may represent circuitry that is wired to perform the specific logical functions in the process.

FIG. 14 illustrates a method 1400 for energy harvesting and distribution in accordance with some examples of the present technology. The method 1400 begins in block 1402 with harvesting energy via an energy harvester device (e.g., energy harvester device 1302 described above). In block 1404, the method 1400 involves determining one or more power parameter(s) of at least one device. In various implementations, the one or more power parameter(s) can be determined via the energy harvester device 1302, or may instead be obtained or received via other devices of the system (e.g., external receiver devices 1304 of the system 1300 described previously).

Among examples, the power parameter can characterize energy captured via the energy harvester device 1302 (e.g., total amount of energy captured over a given time, a rate of energy captured, etc.), an energy storage level of the energy storage of the energy harvester device 1302 (e.g., an energy storage percentage, an estimated time to depletion of the energy storage, etc.), energy consumed via the energy harvester device 1302 (e.g., total amount of energy consumed over a given period of time, a rate of energy consumption over a given period of time, etc.), power transmitted via the wireless power transmitter of the energy harvester device 1302 (e.g., a total amount or rate of power transmitted over a given period of time), an energy storage level of one or more of the external devices 1304, power consumed via one or more of the external devices 1304, a battery age or number of charge cycles for any of the devices 1302 or 1304, a battery or device temperature, a device signal strength (e.g., Wifi received signal strength indicator (RSSI), a zone configuration (e.g., whether devices are part of a bonded zone for audio playback, an energy zone group, etc.), or any other suitable characteristic relating to energy storage, transfer, and consumption via the energy harvester device 1302 and/or the external receiver devices 1304.

At block 1406, the method 1400 includes modifying operation of the energy harvester device 1302 and/or another device in the environment (e.g., external receiver devices 1304) based on the power parameter(s). For instance, based on the power parameter, a controller may modify operation of the energy harvester device 1302 in order to optimize its performance and efficiency. In various implementations, modifying operation of the energy harvester device 1302 may comprise one or more of: modifying an amount or duration of wireless power transmission: modifying a selection of external devices 1304 designated for receiving wireless power: modifying audio playback via one or more audio transducers of the energy harvester device 1302 (e.g., decreasing volume and/or outputting less low-frequency content when energy harvesting and/or energy storage is low); disabling one or more microphones of the energy harvester device 1302: or placing the energy harvester device 1302 in an idle mode (e.g., disabling any onboard microphones, audio transducers, or other components of the device 1302 to reduce power consumption).

Among examples, if the power parameter indicates that the energy harvester device 1302 is harvesting a large amount of energy, the amount of wireless power transmitted to external receiver devices 1304 can be increased. Conversely, if the power parameter indicates that the energy harvester device 1302 is harvesting a lower amount of energy (e.g., due to clouds covering the sun in the case of a solar energy harvester), the energy harvester device 1302 may reduce the amount of wireless power transmitted to external receiver devices 1304. Additionally or alternatively, the energy harvester device 1302 can select among the external receiver devices 1304 such that only a subset of the external receiver devices 1304 receives wireless power at a given time. This can be based on playback responsibilities of the receiver devices 1304, energy storage levels of those devices 1304, or other such factors.

In some implementations, based on the power parameter, the system 1300 may modify operation of at least one of the external devices 1304 in order to optimize its performance and efficiency. For example, modifying operation of at least one of the external receiver devices 1304 may include: modifying audio playback via at least one of the external audio playback devices 1304 (e.g., decreasing volume and/or outputting less low-frequency content when energy harvesting and/or energy storage is low): disabling one or more microphones of at least one of the external devices 1304: or placing at least one of the external audio playback devices in an idle mode.

In some embodiments, the energy harvester device 1302 may transition between a wireless power transmission mode and a wireless power receiver mode based on the power parameter. For example, when the power parameter indicates that the energy harvester device 1302 has sufficient energy to power itself and one or more external receiver devices 1304 (which may be in an idle mode), the device may enter a wireless power transmission mode in which it transmits wireless power to the designated devices. On the other hand, when the power parameter indicates that the energy harvester device 1302 has low energy or needs additional energy to meet its demand, the device may enter a wireless power receiver mode in which it receives wireless power from one or more external transmitter devices within the environment. In some implementations, the energy harvester device 1302 can also transition to a grid power mode in which the device 1302 draws power from the electrical grid. This can be useful during periods in which energy harvesting is insufficient to power the energy harvester device 1302 and/or the external receiver devices 1304. In some instances, this transition between modes of the energy harvester device 1302 can be based on location (e.g., when a portable device is moved from a sunny location outside to a dark room indoors), schedule (e.g., time of day, day of the week, etc.), environmental conditions, and/or other such factors.

In some embodiments, the system 1300 can provide guidance to a user regarding device positioning within the environment based at least in part on the power parameter. For example, this may help the user optimize the wireless power transfer efficiency by adjusting the location and orientation of the energy harvester device 1302 and/or one or more external receiver devices 1304. Such positioning guidance can take the form of audio output, indicator lights, a visual output provided via a controller device, or any other suitable output perceptible by a user.

In some implementations, the amount of energy harvested via the energy harvester device(s) 1302 can be tracked via the system 1300 over time. Optionally, this value can be represented as energy “credits” that offset or displace an equivalent amount of grid power that would have otherwise been consumed by the energy harvester device(s) 1302 or via one or more external devices 1304 that were powered via the energy harvester device(s) 1302. In some instances, a single energy harvester device 1302 or a set of energy harvester devices 1302 in the system 1300 may be capable of receiving sufficient harvested energy such that the total energy harvested by the single device(s) 1302 exceeds the standby power consumption of the remaining devices (e.g, external receiver devices 1304) within the system 1300. In such circumstances, rather than distributing excess energy to the other receiver devices 1304 via wireless power transfer, the energy harvester device 1302 may instead retain the harvested energy itself by storing the excess energy in its own energy storage (e.g., battery), and the stored amount can be tracked as an energy credit. Such energy credits may, for instance, be presented visually via a user interface component of a controller device (e.g., a smartphone or computer screen) or otherwise.

Some users may have concerns relating to safety of wireless power transmission within their environment. Accordingly, in some embodiments, the energy harvester device 1302 may detect a user presence in the environment and cease wireless power transmission based on the user presence detection. FIG. 15 illustrates an example method 1500 for energy harvesting and distribution in which wireless power transfer is ceased in response to detection of a nearby user.

The method 1500 begins in block 1502 with harvesting energy via an energy harvester device (e.g., energy harvester device 1302). In block 1504, the energy harvester device 1302 wirelessly transmits power to one or more receiver devices (e.g., receiver device(s) 1304). The method 1500 continues in block 1506 with detecting a user presence, and in block 1508 the energy harvester device 1302 ceases wireless power transmission to the one or more receiver devices 1304.

In some examples, when the user presence detection indicates that there is no user within the range of the energy harvester device 1302 or within the range of one or more external receiver devices 1304 powered by the energy harvester device 1302, the energy harvester device 1302 may stop transmitting wireless power to save energy and avoid unnecessary radiation. In various examples, user presence detection can be based on RSSI signals from a user's smartphone or other internet-connected device, by optical sensing of movement in the environment, by acoustic localization and detection techniques, by measuring a power receipt parameter for wirelessly transmitted power (e.g., a rapid drop in received wireless power can indicate a user has moved into the line of sight between the transmitter and receiver devices), or any other suitable method for detecting the presence of a user within an environment and/or in a location between the energy harvester device 1302 and one or more external receiver devices 1304. Optionally, wireless power transmission can be reinitiated after a predetermined period of time in which no user presence is detected within the environment. In some implementations, in addition to or instead of detecting the presence of a user, the presence of any living being (e.g., pets, plants) can be detected, and transmission may be modulated (e.g., suspended, redirected along a different path, etc.) based on the detection. User detection methods may incorporate any of the techniques described in commonly owned U.S. Pat. Nos. 9,084,058 and 10,277.981, each of which is hereby incorporated by reference in its entirety.

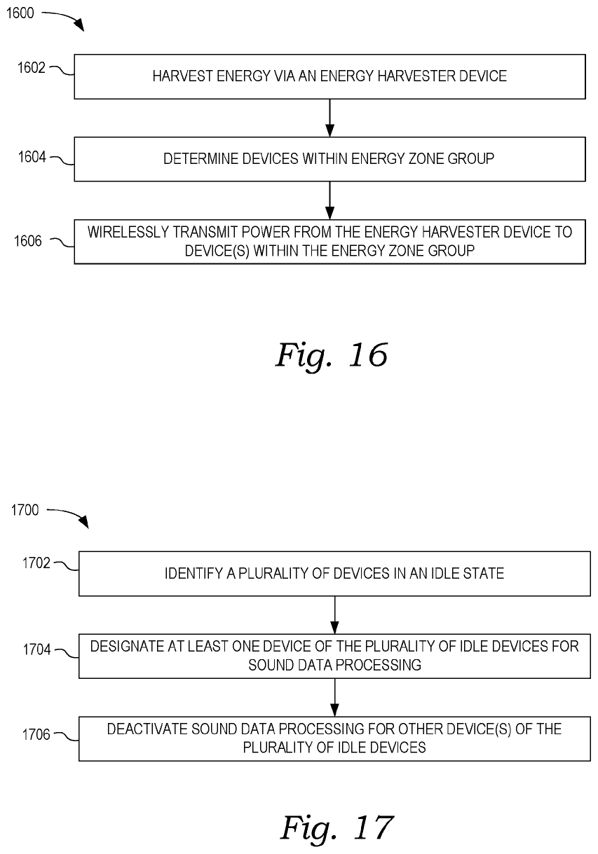

FIG. 16 illustrates another method 1600 for energy harvesting and distribution in accordance with examples of the present technology. In various implementations, it can be useful to group various devices within an environment into energy zone groups. In various implementations, an energy zone group can operate in a manner similar or identical to the “power group” described elsewhere herein. Such energy zone groups can be identical or distinct from media playback synchrony groups, and such groups may be fully overlapping, partially overlapping, or completely non-overlapping with one another.

With respect to FIG. 16, the method 1600 begins in block 1602 with harvesting energy via an energy harvester device (e.g., energy harvester device 1302). In block 1604, the method involves determining or identifying devices with an energy zone that includes the energy harvester device 1302. And in block 1606, the energy harvester device 1302 wirelessly transmits power to the identified device(s) within the energy zone. Optionally, the energy harvester device 1302 transmits power only to those devices within the energy zone group, and does not transmit wireless power to devices that are not within the energy zone group, even if they are in proximity to the energy harvester device 1302.

In some embodiments, an energy zone group may be formed based at least in part on proximity of the energy harvester device 1302 to the external receiver device(s) 1304. Proximity may be determined based on one or more of: a signal strength of wireless power transmission between devices: a time-of-flight measurement between devices: or acoustic localization signals transmitted between devices. For example, the energy harvester device 1302 may measure the signal strength of wireless power transmission with each external receiver device 1304 and select those with higher signal strength for forming an energy zone group. Alternatively, or additionally, the energy harvester device 1302 may measure the time-of-flight of electromagnetic waves between itself and each external receiver device 1304 and select those with shorter time-of-flight for forming an energy zone group. In some examples, the energy harvester device 1302 may transmit acoustic localization signals that are detected by the various receiver devices 1304, and a relative distance can be determined based on the acoustic signals. Those devices within a predetermined distance may then be selected for forming an energy zone group. As such, devices within a given room, household, predetermined distance, or other such location-based parameters can be automatically grouped together into an energy zone group. In such instances, a portable device moving around an environment may be automatically removed from and/or added to respective energy zone groups. In some examples, devices can be grouped together into an energy zone group via manual user intervention, such as user input via a control device, voice control, or other such user input.

In some embodiments, the energy zone group formation may be independent of audio playback responsibilities of the external receiver devices 1304. For example, the system 1300 may select external receiver devices 1304 for receiving wireless power from the energy harvester device 1302 based on their proximity or priority, regardless of whether particular audio playback devices are grouped together for synchronous play back.

In some implementations, to conserve power consumption, it can be useful to modify particular device functionality or responsibilities within the energy zone group. FIG. 17 illustrates one example method 1700 for energy management for audio playback devices in accordance with examples of the present technology. As illustrated, the method 1700 begins in block 1702 with identifying a plurality of devices in an idle state (e.g., devices that are not currently playing back audio or actively processing voice input). At block 1704, at least one of the plurality of idle devices is selected for sound data processing (e.g., the microphone(s) of the selected device are placed in an active state to capture sound data and process the sound data to detect a wake word, to perform acoustic echo cancellation, or other suitable operations). And at block 1706, sound data processing is deactivated for each of the other idle devices (e.g., microphones of these devices are disabled and/or sound data captured via such microphones is not actively processed).

In some instances, an audio playback device may still process sound data even while in an idle state, such as by continuously monitoring for a wake word to be spoken by a user. While such wake word monitoring consumes less power than full processing of a user's voice input, the wake word monitoring still does contribute to power consumption. By identifying only a single device within a group of idle devices (which may or may not be grouped together into an energy zone group), the overall power consumption is reduced while maintaining the collective ability to monitor for a wake word spoken by a user.

In the illustrated examples described above, the devices may be shown as audio play back devices. In some examples, however, one or more of the devices may comprise other types of devices including smartphones, tablets, video display devices (e.g., televisions), internet of things (IoT) devices such as sensors, cameras, microphones, thermostats, light sources, smart doorbells, etc.

VII. Wirelessly Powering Wearable Audio Playback Devices via Accessory Power Devices

Wearable devices are often configured for wireless operation, for instance by including an integrated energy storage (e.g., a rechargeable battery) and other components for wireless data communication. Examples of such wearable devices include wearable audio playback devices such as headphone devices (e.g., over-ear headphones, on-ear headphones, in-ear headphone devices such as earbuds, etc.), smartglasses, headsets, extended-, virtual-, augmented-, or mixed-reality visors or headsets with integrated audio output components, smartwatches, or other suitable form factor. While the reliance on internal energy storage devices (e.g., batteries) to facilitate wireless operation of such devices is convenient, there are some downsides to this approach. For instance, in some cases the wearable audio playback devices may not be easily accessible for repair (e.g., in-ear devices such as earbuds that are glued or welded shut). As a result, when the initial battery life expires for such devices, the entire device is typically discarded even though the non-battery components may still have useful life remaining. Additionally, the sole reliance on an on-board battery to power a wearable playback device can add undesirable mass to the device, leading to user discomfort or annoyance.

In these and other scenarios, it can be useful to provide some or all of the power for operation of a wearable audio playback device from a separate accessory power device. In particular, the accessory power device can supply power (e.g., via wireless power transfer (WPT)) to the wearable audio playback device. In some implementations, the accessory power device can also be wearable, for instance taking the form of a neck-wom device, headband, earring, item of clothing, etc. The accessory power device can optionally have a larger battery capacity and/or an increased ease of repair compared to the wearable audio playback device. By supplying at least some of the operating power for a wearable audio playback device from a separate accessory power device, the total useful life of the wearable audio playback device can be extended (e.g., due to consumption of power via its internal battery at a lower rate). Additionally or alternatively, the wearable audio playback device can perform certain functions it would not otherwise be able to perform (e.g., extending a period of playback before recharging is required, outputting audio at a higher volume, extending the period of operation of an on-board microphone or other components, etc.). In some examples, the battery size can be reduced, or the battery even eliminated, within the wearable audio playback device, thereby reducing costs. In some implementations, the battery operation window may be optimized for significantly longer periods, e.g., greater than 5 years, 10 years, etc.

In various examples, a wearable audio playback device can be configured to receive wireless power. To enable this functionality, the wearable audio playback device can include a wireless power receiver therein, and one or more wireless power transmitter devices can be provided in the vicinity of the wearable audio playback device. Such a transmitter device can include a separate accessory power device, which can be enclosed within a separate housing and spaced apart from the wearable audio playback device without wired or other such connection between the two. The accessory power device can be a wearable component (e.g., having a form factor to be worn about the user's neck, as an earring, headband, a hat or other headgear, wristband, clipped onto the user's clothing, integrated within the user's clothing, etc.). In various implementations the accessory power device can be another play back device (e.g., a soundbar, subwoofer, or any playback device having a wired power connection), or a non-playback device (e.g., a wearable, portable, or stationary device that provides wireless power to the wearable audio playback device without itself driving audio output). In some examples, for instance, a wireless power source can be included in a device or object typically positioned near a wearer's head such as a helmet, a headrest, a seat, a light source (e.g., an overhead lamp), etc.

In some examples, the wearable audio playback device and/or the accessory power device can include both a wireless power receiver and a wireless power transmitter, such that the device may be used in either configuration, or in some instances may be used in both configurations simultaneously (e.g., as a “relay” in which a device receives wireless power from an external transmitter device and transmits wireless power to an external receiver device). In some instances, a plurality of such devices can transfer wireless power among one another in a mesh configuration, with the particular device-to-device transmission being selected to provide the desired power levels, device performance, and user experience. Additional examples of wireless power transmission are provided in commonly owned International Application No. PCT/US2021/071327, entitled “Wireless Power Transfer for Audio Playback Devices,” which is hereby incorporated by reference in its entirety.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to a) charge an onboard battery and/or b) operate one or more components of the receiver device (e.g., to power at least one amplifier of a play back device). In various examples, a single playback device (or other device) can be both a wireless power transmitter and a wireless power receiver, while in other examples a particular device may be only a transmitter device or only a receiver device.

In various examples disclosed herein, such wireless power transfer can include mid- or long-range wireless power transfer. As used herein, mid- and long-range wireless power transfer includes wireless power transfer capability over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer. In some examples, the distance is greater than 1 m (e.g., 5 m, 10 m, 20 m, 100 m or more than 100 m). In other examples, the distances may be less than 10 cm. For instance, in some examples, a wireless power transmitter and receiver may only be separated by a distance less than 1 cm, even if one or both of the transmitter and receiver are capable of transmitting over longer distances.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, magnetic resonance coupling, transformer coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling). In certain examples, the wireless power transmission includes sending and transmitting ultrasound. In these scenarios, for instance, the transmitting and receiving devices can include one or more ultrasound transducers. In some examples, one or more of the devices comprises an ultrasound array comprising several ultrasound elements configured to operate as a phased array to transmit ultrasound energy in a particular direction toward a similarly equipped (or perhaps differently equipped) receiver device.

### a. Example Wireless Power Transfer to Wearable Audio Playback Devices

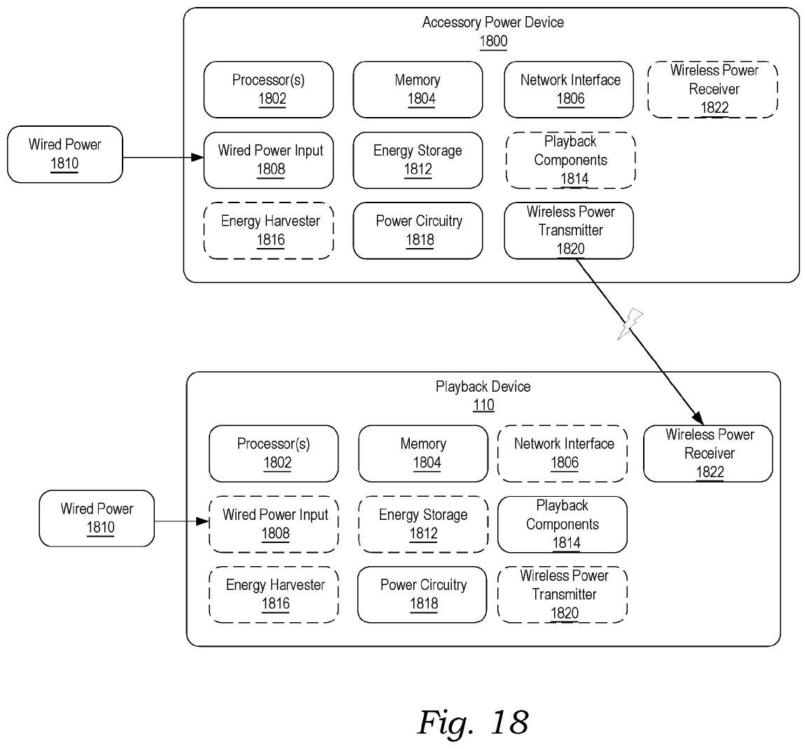

FIG. 18 is a schematic block diagram of an accessory power device 1800 configured to supply wireless power to a playback device 110 having integrated wireless power transfer components. In various implementations, the playback device 110 can be a wearable or portable audio playback device (e.g., in-ear device such as earbuds, on-ear or over-ear headphones, etc.). Among examples, the accessory power device 1800 can also be a wearable or portable device, for instance being configured to be worn about a user's neck, head, attached to or integrated into a user's clothing, etc. In operation, when a user dons both the wearable audio playback device 110 and the accessory power device 1800, the accessory power device 1800 can be within a predetermined distance and/or configuration with respect to the wearable audio playback device 110 (e.g., having a relatively unobstructed line of sight between the two devices, having a separation distance less than 50 cm, 40 cm, 30 cm, 20 cm, 10 cm, etc.) to facilitate wireless power transfer from the accessory power device 1800 to the audio playback device 110. As noted above, this arrangement can beneficially extend the operating life of the audio playback device 110 and/or permit the use of smaller batteries in the wearable audio playback device 110.

As used herein, a “wireless power transfer device” (also referred to as a “WPT device”) includes any device configured to transmit power wirelessly to another receiver device and/or to receive power wirelessly from another transmitter device. In various implementations, an audio playback device can include wireless power transfer components (e.g., a transmitter and/or receiver) and as such the audio playback device 110 can be a WPT device. In some implementations, a WPT device may omit certain audio playback components (e.g., amplifiers, transducers, etc.) and as such a WPT device may not be an audio playback device.

As shown in FIG. 18, an accessory power device 1800 (which can be a WPT device) can include one or more processors 1802, a memory 1804, and a network interface 1806. These can be similar to, identical to, or include, processors 112a, memory 112b, and network interface 112d described above with respect to Figures IC and IF. In various examples, the accessory power device 1800 can include any or all of the features of playback device 110a or NMD 120a described previously herein. In some examples, the network interface 1806 can include one or more transceivers that are configured to communicate via at least one WIFI network, and/or at least one BLUETOOTH network.

Accessory power device 1800 optionally includes a wired power input port 1808 that is configured to be electrically coupled to wired power 1810 (e.g., via 110/220V wall power, a USB-C charger, etc.), such as an AC power port or a USB port (e.g., a USB TYPE-A port, a USB TYPE-B port, a USB TYPE-C port, etc.). The power input port 1808 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 1808 is omitted, and the accessory power device 1800 operates solely on the basis of power received wirelessly from external transmitter device(s) and/or energy generated via energy harvester(s) 1816.

The accessory power device 1800 further includes an energy storage component 1812, which can take the form of a rechargeable battery, a capacitor, a supercapacitor, a hybrid capacitor, or any other suitable component that can store energy. The energy storage component 1812 can be configured to store energy and to facilitate operation of the device (e.g., powering antennas for data communication). In this regard, the energy storage component 1812 can be a battery that has a chemistry that facilitates recharging the battery, such as lithium-ion (Li-ion), nickel-metal hydride (NiMH), etc. The battery can be sized such that the processor(s) 1802 and other components of the accessory power device 1800 can operate on battery power alone for an extended amount of time without the battery needing to be recharged. The battery can be charged using power from one or more other components in the device 1800 (e.g., wired power input port 1808, wireless power receiver 1822, energy harvester 1816, etc.).

As noted previously, in some examples, the accessory power device 1800 can include audio playback components 1814 (e.g., one or more transducers, audio processing circuitry, microphones, voice processing circuitry, etc.), and as such the accessory power device 1800 can include or be part of an audio playback device or a network microphone device as described elsewhere herein. In various examples, such an audio playback device can be a soundbar, a subwoofer, a headphone device, a hearable device, a wearable device (e.g., a smartwatch), a portable audio playback device, an architectural playback device, or a video playback device. In some examples, the audio playback components 1814 are omitted, and the accessory power device 1800 can supply wireless power to the playback device 110 without itself driving any audio output.

The accessory power device 1800 optionally includes one or more energy harvesters 1816. Energy harvesters 1816 may include those devices configured to derive power from energy sources in the environment (e.g., solar energy, thermal energy, wind energy, salinity gradients, kinetic energy, sound energy, etc.). For example, the energy harvesters 1816 can include one or more photovoltaic cells configured to convert received light into a voltage and current. Any of a variety of energy harvesters 1816 may be included in the accessory power device 1800. Examples of such energy harvesters include photovoltaic cells, thermoelectric generators, micro wind turbines, piezoelectric crystals, electroacoustic transducers, kinetic energy harvesters, and/or mechanical energy harvesters (e.g., triboelectric nanogenerators).

The accessory power device 1800 can additionally include power circuitry 1818 and a wireless power transmitter 1820. In some implementations, the accessory power device 1800 also includes a wireless power receiver 1822. In operation, the accessory power device 1800 can transmit wireless power to an external receiver device (e.g., playback device 110) via the transmitter 1820, with the power circuitry 1818 controlling some or all of the functions associated with these operations. In some examples, the wireless power transmitter 1820 can be configured to transmit power below a predetermined threshold to ensure safety. For instance, the wireless power transmitter 1820 can be configured to transmit less than 5 watts, 4 watts, 3 watts, 2 watts, 1 watt, 500 milliwatts, or less. In some examples, the wireless power transmitter 1820 is configured to transmit power above 5 watts.

The wireless power transmitter 1820 can include any component or combination of components capable of transmitting wireless power to an external wireless power receiver device. Such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power transmitter 1820 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from the wireless power transmitter 1820). In various examples, the wireless power transmitter 1820 in such instances can include an optical source such as a laser, a microwave source, an antenna (e.g., directional antennas, phased array antennas, etc.), or any other source of electromagnetic radiation. In some instances, the wireless power transmitter 1820 can include one or more steering components configured to direct, focus, or steer wireless power. Such steering components can include, for example, one or more lenses, mirrors, directional antennas, ultrasound arrays, waveguides, and/or other suitable components.

Additionally or alternatively, the wireless power transmitter 1820 can be configured to transmit wireless power using non-radiative techniques such as electromagnetic coupling (e.g., inductive coupling, resonant inductive coupling, capacitive coupling, resonant capacitive coupling, magnetodynamic coupling, magnetic resonance coupling etc.). In such instances, the wireless power transmitter 1820 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

With continued reference to FIG. 18, the accessory power device 1800 can include power circuitry 1818 configured to receive power from the energy storage component 1812, the wired power input 1808, and/or the wireless power receiver 1822, and, using the power obtained therefrom, (1) charge one or more onboard batteries, (2) transmit, receive, and/or process data via the network interface 1806 and processor(s) 1802, and/or (3) any other suitable operations. The power circuitry 1818 can be configured to perform any of a variety of power-related tasks including, for example, one or more of the following: (1) power conversion (e.g., AC-AC conversion, AC-DC conversion, DC-AC conversion, and/or DC-DC conversion): (2) power regulation: (3) battery charging; and/or (4) power monitoring (e.g., battery monitoring). Examples of electrical components that may be integrated into the power circuitry 1818 include transformers, rectifiers, inverters, converters, regulators, battery chargers, and/or power management integrated circuits (PMICs). In some examples, such power circuitry 1818 can be integrated into either or both the wireless power transmitter 1820 and the wireless power receiver 1822.

In some examples, the power circuitry 1818 can include battery circuitry that facilitates monitoring a state of a battery or other energy storage component. In these examples, the battery circuitry can identify battery state information that includes information regarding one or more of the following battery states: a state-of-charge (SoC), temperature, age, and/or internal impedance. The battery circuitry can communicate the battery state information to, for example, the processor 1802.

The power circuitry 1818 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, fly back, resonant, etc, switching regulator circuitry. The regulation circuitry can include one or more linear voltage regulators such as low-dropout (LDO) regulators. The regulation circuitry can be configured to output one or more fixed DC voltages (e.g., +5V, +12V) or AC voltages. In some implementations, matching circuits (passive or active) can be configured to maximize efficiencies under various conditions (e.g., load, transmitted power, environment, distance from transmitter device, etc.). Additionally or alternatively, power circuitry 1818 can include an inverter, which may be particularly useful for bidirectional WPT devices.

In various examples, the accessory power device 1800 can also include further components, such as one or more user interface components (e.g., touch sensitive surface, screen, buttons, etc.), one or more microphones and associated electronics (e.g., to facilitate active noise cancellation and/or acoustic echo cancellation via the wearable playback device 110), or any other suitable components. In some implementations, the accessory power device 1800 can include one or more sensors (e.g., accelerometer, gyroscope, etc.) that may facilitate tracking movement of a user's head. Associated sensor data can then be used to facilitate playback via the wearable playback device 110 (e.g., using a head related transfer function (HRTF) to render spatial audio via the wearable play back device 110 that is based on a user's head position and/or orientation).

With continued reference to FIG. 18, the accessory power device 1800 can be in electrical communication with the playback device 110. For instance, the accessory power device 1800 can transmit power wirelessly (e.g., via wireless power transmitter 1820 of the accessory power device 1800) to the playback device 110. The playback device 110 can include some or all of the components described above with respect to the accessory power device 1800. For instance, as shown in FIG. 18, the playback device 110 can include one or more processors 1802, memory 1804, a network interface 1806, and wired power input 1808 configured to receive power from a connection to wired power 1810.

The play back device 110 can optionally include an on-board energy storage 1812 (e.g., rechargeable battery, ultracapacitor, etc.) and/or energy harvester components 1816. In some implementations, the playback device 110 includes no on-board energy storage and instead relies exclusively on wireless power supplied by the accessory power device 1800. In the illustrated example, the playback device 110 includes playback components 1814 (e.g., amplifiers, audio transducers, etc.) to facilitate audio playback. Optionally, the play back device 110 can also include one or more microphones and related circuitry to capture and process sound data (e.g., to process user voice comments, perform active noise cancellation, acoustic echo cancellation, or other suitable processes).

The playback device 110 includes a wireless power receiver 1822, which as noted above can be configured to receive wireless power from a corresponding wireless power transmitter 1820 of another device (e.g., the accessory power device 1800). As noted previously, power circuitry 1818 can be configured to perform a variety of power-related tasks, including receiving power via the wireless power receiver 1822 and providing power to various components (e.g., processor(s) 1802, play back components 1814), charging the energy storage 1812, monitoring a state (e.g., health, charge level, etc.) of the energy storage 1812, or any other suitable power-related tasks.

In some examples, instead of or in addition transmission of wireless power between the accessory power device 1800 and the playback device 110, the two devices can transmit data in unilateral or bilateral fashion. In some implementations, the devices can communicate over a wireless network connection via their respective network interfaces 1806 (e.g., via a local area network, personal area network, Bluetooth connection, etc.). These devices may also communicate with additional devices via their respective network interfaces 1806 (e.g., other audio playback devices within the environment, with remote computing devices over a wide area network, etc.). Among examples, the accessory power device 1800 may obtain audio data (e.g., via one or more remote computing devices) and transmit the audio data to the playback device 110 for play back.

In some examples, the accessory power device 1800 can transmit data (e.g., including the audio content) to the wearable audio playback device 110 (and vice versa) via the same mechanism used to transfer wireless power. For instance, the wireless power transfer signal can be used as a carrier wave, which is then modulated to encode data therein. Among examples, the carrier wave can take the form of light emitted via a laser, the AC current through an inductive coil, etc., which can then be modulated to incorporate data therein. At the receiver device, the wireless power signal can be demodulated to recover the transmitted data while also being converted to electrical energy for operation of the receiver device. In various examples, modulation of the wireless power signal to transmit data therein can include amplitude modulation, frequency modulation, phase modulation, pulse-width modulation, spread spectrum modulation, or any other suitable modulation scheme and/or combination of modulation schemes. In at least some instances, the data transmitted via the wireless power signal can include audio content, synchronization signals, power level indicators, device identifiers, audio content metadata, power parameters, or other such data. It should be appreciated that the data to be transmitted may (or may not) be encoded according to one or more encoding schemes prior to transmission to, for example, reduce data errors in transmission (e.g., a channel encoding scheme that adds redundancy) and/or compress the data for transmission (e.g., a compression scheme that reduces the size of the data).

In some implementations, when data communication with the wearable audio playback device 110 occurs by using the wireless power transfer signal as a carrier wave, a conventional network interface (e.g., WiFi or Bluetooth antenna and associated electronics) can be omitted from the wearable audio playback device 110 altogether. This may advantageously further reduce the amount of electronic waste associated with disposing of the wearable audio playback device 110 once the device is no longer functional.

In some instances, the playback device 110 may transmit data to the accessory power device 1800, such as data indicative of device state or operation. For example, the data transmitted to the accessory power device 1800 may relate to the power consumption, charge level, battery health, or other power parameter associated with the playback device 110. In response to certain power parameters, the accessory power device 1800 may modify its operation. For example, in response to an indication that the on-board energy storage 1812 of the playback device 110 has fallen below a predetermined threshold, the accessory power device 1800 may initiate wireless power transfer to the playback device 110. As another example, in response to an indication that the on-board energy storage 1812 of the play back device 110 has risen above a predetermined threshold, the accessory power device 1800 may cease wireless power transfer to the play back device 110. In additional examples, the accessory power device 1800 may initiate, cease, or modify wireless power transmission based on data indicating a power receipt parameter (e.g., a low power receipt parameter may indicate an obstruction between the two devices, and hence power transmission may be temporarily suspended). In some instances, power transmission can be scheduled based on a user input, a detected user behavior, detected environmental conditions, other sensor data, or any other suitable input parameter.

In some implementations, a given accessory power device 1800 may transmit data and/or power to multiple receiver devices, one or more of which may be wearable audio playback devices. In such cases, the accessory power device 1800 may optionally send both power and data to a first set of one or more devices, while sending only one of power and/or data to a second set of one or more devices. In one example, earbuds may receive both power and data from the accessory power device 1800, but a nearby user wearing battery-powered headphones may receive only data (e.g., to listen to the same audio content) without also receiving wireless power.

### b. Example Wearable Playback Device Configurations

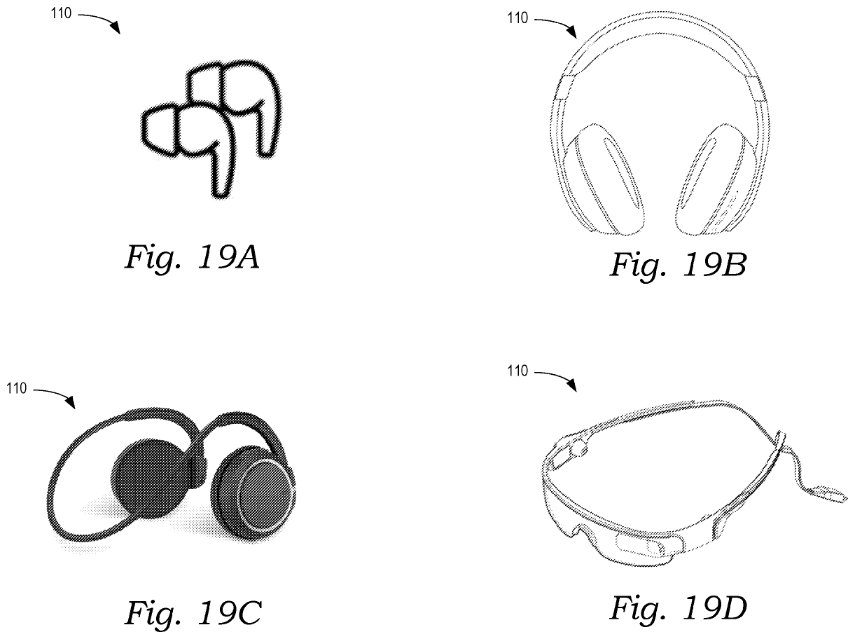

As noted previously, a wearable audio playback device 110 can assume a variety of different form factors in different implementations of the present technology. FIGS. 19A-19D illustrate a variety of example form factors for a wearable audio playback device 110. In these and other configurations, a wearable audio playback device 110 can be configured to receive some or all of its operating power via wireless power transfer from a separate accessory power device 1800, which may also be wearable by the user.

In some examples, the playback device 110 may take the form of an in-ear headphone device (FIG. 19A), in which separate housings are provided for left and right ears, each with a portion configured to be placed within or adjacent to a user's ear canal. As shown in FIG. 19B, the play back device 110 may also take the form of an over-ear headphone device, in which two earpieces (each configured to be placed over a user's ear) are connected via a headband configured to extend over the top of a user's head. FIG. 19C illustrates yet another example playback device 110 in the form of an on-ear headphone device, in which left and right earpieces are connected via a tether configured to extend around the back of a user's neck.

It should be appreciated that the playback device 110 may take the form of other wearable devices separate and apart from a headphone device. Wearable devices may include those devices configured to be worn about a portion of a subject (e.g., a head, a neck, a torso, an arm, a wrist, a finger, a leg, an ankle, etc.). For example, as shown in FIG. 19D, the playback device 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

### c. Example Accessory Power Device Configurations

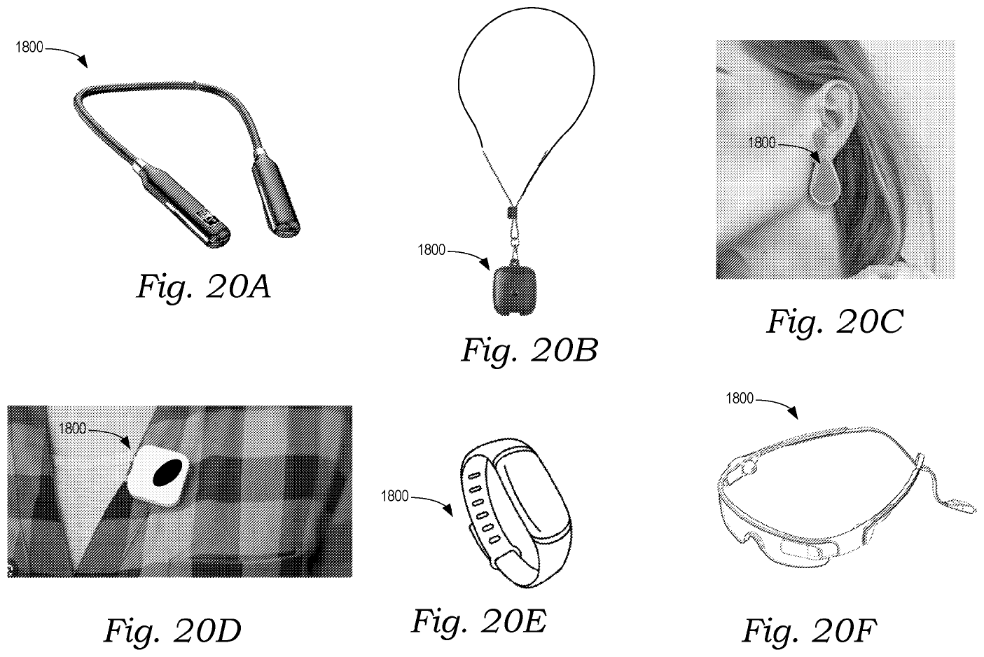

An accessory power device 1800 can likewise assume a variety of different form factors in different implementations of the present technology. FIGS. 20A-20F illustrate a variety of example form factors for a wearable accessory power device 1800. In these and other configurations, the wearable accessory power device 1800 can be configured to transmit wireless power to a wearable audio playback device 110 being worn by the user.

In some examples, the accessory power device 1800 can be configured to be worn about a user's neck, either by providing a U-shaped body that extends partially around a user's neck (FIG. 20A), or by providing a necklace or lanyard that carries an enclosure containing the components of the accessory power device 1800 (FIG. 20B). In additional examples, the accessory power device 1800 can be configured to be worn by a user as an article of clothing, such as an earring (FIG. 20C), clipped onto a user's shirt or other attire (FIG. 20D), integrated into a user's clothing (e.g., integrated into a headband, shirt, scarf, hat) or other wearable item (e.g., backpack, purse, etc.). In some implementations, the accessory power device 1800 can include or be integrated within another smart device, such as a smartwatch (FIG. 20E), smartglasses (FIG. 20F), or other such device.

### d. Example Methods

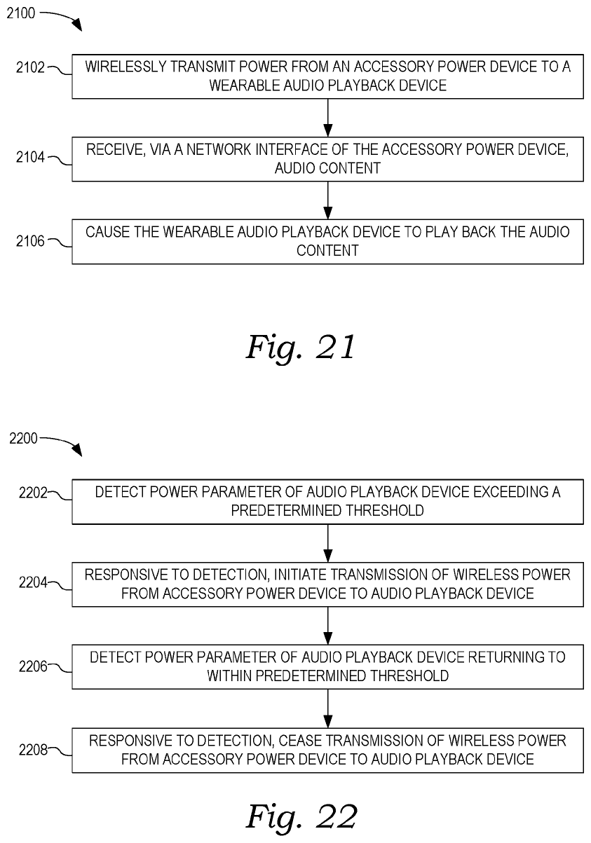

FIGS. 21 and 22 illustrate example methods in accordance with the present technology. The methods 2100 and 2200 can be implemented by any of the devices described herein, or any other devices now known or later developed. Various embodiments of the methods 2100 and 2200 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 2100 and 2200 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 21 and 22 may represent circuitry that is wired to perform the specific logical functions in the process.

FIG. 21 illustrates a method 2100 for wirelessly powering a wearable audio playback device in accordance with some examples of the present technology. The method 2100 begins in block 2102 with wirelessly transmitting power from an accessory power device to a wearable audio playback device. In some instances, the accessory power device is also a wearable device and is being worn by the user concurrently with the wearable audio playback device. In some examples, when worn by the user, the wearable audio playback device (e.g., earbuds) can be within a threshold distance of the accessory power device (e.g., worn about the user's neck) to facilitate wireless power transfer between the two devices.

At block 2104, the method 2100 involves receiving, via a network interface of the accessory power device, audio content. For instance, audio content may be received over a local area network, a wide area network, or otherwise received at the accessory power device.

The method 2100 continues in block 2106 with causing the wearable audio play back device to play back the audio content. In some examples, this includes the accessory power device transmitting the audio content to the wearable audio playback device. Such data transmission can be conducted via the network interface (e.g., via a local area network connection, a personal area network connection, via direct wireless connection such as Bluetooth, etc.). In some examples, the accessory power device can transmit data (e.g., including the audio content) to the wearable audio playback device via the same mechanism used to transfer wireless power. For instance, the wireless power transfer signal can be used as a carrier wave, which is then modulated to encode data therein as noted previously.

FIG. 22 illustrates another method 2200 for wirelessly powering a wearable audio playback device in accordance with some examples of the present technology. The method 2200 begins in block 2202 with detecting a power parameter of an audio playback device that exceeds a predetermined threshold (e.g., falling below or rising above a predetermined threshold, as appropriate). This can be, for instance, an indication that an on-board energy storage of a wearable audio playback device has fallen below a specified charge level, an indication that a power consumption rate has risen above a predetermined threshold, or any other suitable power parameter and associated threshold.

In block 2204, the method 2200 involves initiating transmission of wireless power from an accessory power device to the wearable audio playback device. For instance, the power parameter may be received at the accessory power device and then evaluated to determine whether a threshold is exceeded. In some examples, the determination can be made at the wearable audio playback device (or at another device within a media playback system) and then transmitted to the accessory power device. In response to this detection, the accessory power device can initiate wireless power transmission to the audio playback device.

The method 2200 continues in block 2206 with detecting a power parameter of audio playback returning to within a predetermined threshold. For instance, the on-board battery of the wearable audio playback device may have a charge level that exceeds its predetermined threshold, or the power consumption rate may decrease below a given threshold.

In block 2208, in response to this detection, the accessory power device ceases transmitting wireless power to the wearable audio playback device. This approach can advantageously conserve power by only transmitting wireless power when certain conditions are met (e.g., indicating that the wearable audio playback device requires power to continuously operate).

Among examples, the power parameter can characterize energy captured via an energy harvester device (e.g., total amount of energy captured over a given time, a rate of energy captured, etc.), an energy storage level of the energy storage of the wearable play back device (e.g., an energy storage percentage, an estimated time to depletion of the energy storage, etc.), energy consumed via the wearable playback device (e.g., total amount of energy consumed over a given period of time, a rate of energy consumption over a given period of time, etc.), power received via the wireless power receiver of the wearable playback device (e.g., a total amount or rate of power receipt over a given period of time), an energy storage level of one or more external devices, power consumed via one or more of the external devices, a battery age or number of charge cycles, a battery or device temperature, a device signal strength (e.g., Wi-Fi received signal strength indicator (RSSI), a zone configuration (e.g., whether devices are part of a bonded zone for audio playback, an energy zone group, etc.), or any other suitable characteristic relating to energy storage, transfer, and consumption via the wearable audio playback device.

In some examples, operation of the accessory power device and/or operation of the wearable playback device can be modified based on one or more power parameters. For instance, based on the power parameter, a controller may modify operation of the wearable audio playback device and/or of the accessory power device in order to optimize its performance and efficiency. In various implementations, modifying operation may comprise one or more of: modifying an amount or duration of wireless power transmission: modifying a selection of external devices designated for receiving wireless power: modifying audio playback (e.g., decreasing volume and/or outputting less low-frequency content when energy storage is low): disabling one or more microphones: or placing the device in an idle mode (e.g., disabling any onboard microphones, audio transducers, wireless power transfer components, or other components of the device to reduce power consumption).

In the illustrated examples described above, the devices (e.g., play back device 110 or accessory power device 110) may be shown as audio playback devices or other particular devices. In various examples, however, one or more of the devices may comprise other types of devices including smartphones, tablets, video display devices (e.g., televisions), internet of things (IoT) devices such as sensors, cameras, microphones, thermostats, light sources, smart doorbells, etc. Additionally, while various examples relate to wearable devices, in some implementations the audio playback device 110 and/or the accessory power device 1800 may be non-wearable (e.g., stationary or portable devices not configured to be worn by a user). In further implementations, the technology described herein can be applied to devices 110 that are configured to be implanted, whether or not the devices take the form of audio playback devices.

### VIII. Conclusion

The above discussions relating to playback devices, controller devices, wireless power transfer devices, play back zone configurations, and media/audio content sources provide only some examples of operating environments within which functions and methods described below may be implemented. Other operating environments and configurations of power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory. DVD. CD. Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A media playback system comprising: a first audio playback device comprising one or more first audio transducers and one or more first processors: a second audio playback device comprising one or more second audio transducers, one or more second processors, and an energy storage having a remaining power level; and one or more computer-readable media storing instructions that, when executed by the one or more first processors and/or the one or more second processors of the media playback system, cause the media playback system to perform operations comprising: transmitting power from the first audio playback device to the energy storage of the second audio playback device: receiving, via the first audio playback device, audio data from a content source: determining, based on the remaining power level of the energy storage of the second audio playback device, a crossover frequency: transmitting a second portion of the audio data via the first audio playback device to the second audio playback device, wherein the second portion of the audio data comprises audio frequencies greater than the determined crossover frequency: playing back, via the first audio playback device, a first portion of the audio data comprising audio frequencies less than the crossover frequency; and playing back, via the second audio playback device, the second portion of the audio data in synchrony with playback of the first portion of the audio data via the first audio playback device.

Example 2. The media play back system of any one of the Examples herein, wherein the first audio playback device is a subwoofer, and wherein the second audio playback device is a portable playback device.

Example 3. The media play back system of any one of the Examples herein, further comprising a power cable coupling the first audio playback device and the second audio playback device, and wherein transmitting power from the first audio playback device to the second audio playback device comprises transmitting power from the first audio playback device to the energy storage of the second audio playback device via the power cable.

Example 4. The media play back system of any one of the Examples herein, wherein providing power from the first audio playback device to the second audio playback device comprises wirelessly transmitting power from the first audio playback device to the energy storage of the second audio playback device.

Example 5. The media play back system of any one of the Examples herein, wherein the operations further comprise varying a rate of power transmission from the first audio playback device to the second audio playback device based at least in part on or more of: the audio content, a playback volume of the second audio playback device, and/or a power level of the energy storage of the second audio playback device.

Example 6. The media play back system of any one of the Examples herein, wherein the energy storage comprises at least one of: a battery or a capacitor.

Example 7. The media play back system of any one of the Examples herein, wherein the second audio playback device has a width, a height, and a depth, wherein the depth is the smallest dimension and is less than about 4 inches.

Example 8. The media play back system of any one of the Examples herein, further comprising a wall-mountable bracket configured to removably receive the second audio playback device thereon.

Example 9. The media play back system of any one of the Examples herein, further comprising a third audio playback device comprising one or more third audio transducers, one or more third processors, and a second energy storage, wherein the operations further comprise: transmitting at least a portion of the audio data from the first audio playback device to the third audio playback device; and playing back, via the third audio playback device and in synchrony with the first and second audio playback devices, only a third portion of the audio data, wherein the third portion of the audio data comprises audio frequencies greater than the determined crossover frequency.

Example 10. The media play back system of any one of the Examples herein, wherein the operations further comprise transmitting power from the first audio playback device to the third audio playback device.

Example 11. The media playback system of any one of the Examples herein, further comprising a third audio playback device comprising one or more third audio transducers, one or more third processors, and a second energy storage, wherein the operations further comprise: transmitting power from the first audio playback device to the second energy storage of the third audio playback device: receiving, via the third audio playback device, second audio content from a content source; and playing back, via the third audio playback device and in synchrony with the first and second audio playback devices, at least a portion of the second audio content.

Example 12. The media play back system of any one of the Examples herein, wherein the operations further comprise: determining that the energy storage level of the second audio play back device is less than a predetermined threshold; and ceasing, based on the determination that the energy storage level of the second audio playback device is less than the predetermined threshold, playback of both the first and second audio playback devices.

Example 13. The media play back system of any one of the Examples herein, wherein the operations further comprise ceasing, prior to transmitting the second portion of the audio data via the first audio playback device to the second audio playback device, transmission of the power from the first audio playback device to the energy storage of the second audio playback device.

Example 14. The media play back system of any one of the Examples herein, wherein the operations further comprise: receiving an indication of a position of a listener within a predetermined threshold distance of either the first audio playback device or the second audio playback device; and ceasing, based on the received indication of the listener position, transmission of the power from the first audio playback device to the energy storage of the second audio playback device.

Example 15. The media play back system of any one of the Examples herein, wherein the determining the crossover frequency comprises comparing operational characteristics of the one or more first transducers and the one or more second transducers.

Example 16. The media play back system of any one of the Examples herein, wherein transmitting at least the second portion of the audio data via the first audio playback device to the second audio playback device comprises transmitting individual delays associated with corresponding ones of the one or more second audio transducers.

Example 17. A method comprising: transmitting power from a first audio playback device to a energy storage of a second audio playback device: receiving, via a first audio playback device, audio data from a content source: determining, based on the remaining power level of the energy storage of the second audio playback device, a crossover frequency; transmitting a second portion of the audio data via the first audio playback device to the second audio playback device, wherein the second portion of the audio data comprises audio frequencies greater than the determined crossover frequency: playing back, via the first audio playback device, a first portion of the audio data comprising audio frequencies less than the crossover frequency; and playing back, via the second audio playback device, the second portion of the audio data in synchrony with playback of the first portion of the audio data via the first audio playback device.

Example 18. The method of any one of the Examples herein, wherein the first audio playback device is a subwoofer, and wherein the second audio playback device is a portable play back device.

Example 19. The method of any one of the Examples herein, wherein a power cable couples the first audio playback device and the second audio playback device, and wherein transmitting power from the first audio playback device to the second audio playback device comprises transmitting power from the first audio playback device to the energy storage of the second audio playback device via the power cable.

Example 20. The method of any one of the Examples herein, wherein providing power from the first audio playback device to the second audio playback device comprises wirelessly transmitting power from the first audio playback device to the energy storage of the second audio playback device.

Example 21. The method of any one of the Examples herein, further comprising varying a rate of power transmission from the first audio playback device to the second audio playback device based at least in part on or more of: the audio content, a play back volume of the second audio playback device, and/or a power level of the energy storage of the second audio playback device.

Example 22. The method of any one of the Examples herein, wherein the energy storage comprises at least one of: a battery or a capacitor.

Example 23. The method of any one of the Examples herein, wherein the second audio playback device has a width, a height, and a depth, wherein the depth is the smallest dimension and is less than about 4 inches.

Example 24. The method of any one of the Examples herein, wherein the second audio playback device comprises a wall-mountable bracket.

Example 25. The method of any one of the Examples herein, further comprising: transmitting at least a portion of the audio data from the first audio playback device to a third audio playback device; and playing back, via the third audio playback device and in synchrony with the first and second audio playback devices, only a third portion of the audio data, wherein the third portion of the audio data comprises audio frequencies greater than the determined crossover frequency.

Example 26. The method of any one of the Examples herein, further comprising transmitting power from the first audio playback device to the third audio playback device.

Example 27. The method of any one of the Examples herein, further comprising: transmitting power from the first audio playback device to a second energy storage of a third audio playback device: receiving, via the third audio playback device, second audio content from a content source; and playing back, via the third audio playback device and in synchrony with the first and second audio playback devices, at least a portion of the second audio content.

Example 28. The method of any one of the Examples herein, further comprising: determining that the energy storage level of the second audio playback device is less than a predetermined threshold; and ceasing, based on the determination that the energy storage level of the second audio playback device is less than the predetermined threshold, play back of both the first and second audio playback devices.

Example 29. The method of any one of the Examples herein, further comprising ceasing, prior to transmitting the second portion of the audio data via the first audio playback device to the second audio playback device, transmission of the power from the first audio play back device to the energy storage of the second audio playback device.

Example 30. The method of any one of the Examples herein, further comprising: receiving an indication of a position of a listener within a predetermined threshold distance of either the first audio playback device or the second audio playback device; and ceasing, based on the received indication of the listener position, transmission of the power from the first audio play back device to the energy storage of the second audio playback device.

Example 31. The method of any one of the Examples herein, wherein the determining the crossover frequency comprises comparing operational characteristics of one or more first transducers of the first audio playback device and one or more second transducers of the second audio playback device

Example 32. The method of any one of the Examples herein, wherein transmitting at least the second portion of the audio data via the first audio playback device to the second audio play back device comprises transmitting individual delays associated with corresponding audio transducers of the second audio playback device.

Example 33. One or more tangible, non-transitory computer-readable media storing instructions that, when executed by one or more processors of a media playback system, cause the media play back system to perform operations comprising: transmitting power from a first audio playback device to a energy storage of a second audio playback device: receiving, via a first audio playback device, audio data from a content source: determining, based on the remaining power level of the energy storage of the second audio playback device, a crossover frequency: transmitting a second portion of the audio data via the first audio playback device to the second audio playback device, wherein the second portion of the audio data comprises audio frequencies greater than the determined crossover frequency: playing back, via the first audio playback device, a first portion of the audio data comprising audio frequencies less than the crossover frequency; and playing back, via the second audio playback device, the second portion of the audio data in synchrony with playback of the first portion of the audio data via the first audio playback device.

Example 34. The computer-readable media of any one of the Examples herein, wherein the first audio playback device is a subwoofer, and wherein the second audio playback device is a portable play back device.

Example 35. The computer-readable media of any one of the Examples herein, wherein a power cable couples the first audio playback device and the second audio playback device, and wherein transmitting power from the first audio playback device to the second audio playback device comprises transmitting power from the first audio playback device to the energy storage of the second audio playback device via the power cable.

Example 36. The computer-readable media of any one of the Examples herein, wherein providing power from the first audio playback device to the second audio playback device comprises wirelessly transmitting power from the first audio playback device to the energy storage of the second audio playback device.

Example 37. The computer-readable media of any one of the Examples herein, wherein the operations further comprise varying a rate of power transmission from the first audio playback device to the second audio playback device based at least in part on or more of: the audio content, a playback volume of the second audio playback device, and/or a power level of the energy storage of the second audio playback device.

Example 38. The computer-readable media of any one of the Examples herein, wherein the energy storage comprises at least one of: a battery or a capacitor.

Example 39. The computer-readable media of any one of the Examples herein, wherein the second audio playback device has a width, a height, and a depth, wherein the depth is the smallest dimension and is less than about 4 inches.

Example 40. The computer-readable media of any one of the Examples herein, wherein the second audio playback device comprises a wall-mountable bracket.

Example 41. The computer-readable media of any one of the Examples herein, wherein the operations further comprise: transmitting at least a portion of the audio data from the first audio playback device to a third audio playback device; and playing back, via the third audio playback device and in synchrony with the first and second audio playback devices, only a third portion of the audio data, wherein the third portion of the audio data comprises audio frequencies greater than the determined crossover frequency.

Example 42. The computer-readable media of any one of the Examples herein, wherein the operations further comprise transmitting power from the first audio playback device to the third audio playback device.

Example 43. The computer-readable media of any one of the Examples herein, wherein the operations further comprise: transmitting power from the first audio playback device to a second energy storage of a third audio playback device: receiving, via the third audio playback device, second audio content from a content source; and playing back, via the third audio playback device and in synchrony with the first and second audio playback devices, at least a portion of the second audio content.

Example 44. The computer-readable media of any one of the Examples herein, wherein the operations further comprise: determining that the energy storage level of the second audio playback device is less than a predetermined threshold; and ceasing, based on the determination that the energy storage level of the second audio playback device is less than the predetermined threshold, play back of both the first and second audio playback devices.

Example 45. The computer-readable media of any one of the Examples herein, wherein the operations further comprise ceasing, prior to transmitting the second portion of the audio data via the first audio playback device to the second audio playback device, transmission of the power from the first audio playback device to the energy storage of the second audio playback device.

Example 46. The computer-readable media of any one of the Examples herein, wherein the operations further comprise: receiving an indication of a position of a listener within a predetermined threshold distance of either the first audio playback device or the second audio playback device; and ceasing, based on the received indication of the listener position, transmission of the power from the first audio playback device to the energy storage of the second audio playback device.

Example 47. The computer-readable media of any one of the Examples herein, wherein the determining the crossover frequency comprises comparing operational characteristics of one or more first transducers of the first audio playback device and one or more second transducers of the second audio playback device.

Example 48. The computer-readable media of any one of the Examples herein, wherein transmitting at least the second portion of the audio data via the first audio playback device to the second audio playback device comprises transmitting individual delays associated with corresponding audio transducers of the second audio playback device.

Example 49. A subwoofer comprising: one or more audio transducers: a power transmitter: one or more processors; and one or more computer-readable media storing instructions that, when executed by the one or more processors, cause the subwoofer to perform operations comprising: transmitting, via the power transmitter, power to a playback device; determining a crossover frequency: transmitting, to the playback device, a second portion of the audio data, wherein the second portion of the audio data comprises audio frequencies greater than the determined crossover frequency; and causing playback of the second portion of the audio data via the playback device in synchrony with playback of a first portion of the audio data via the subwoofer, wherein the first portion of the audio data comprises audio frequencies less than the determined crossover frequency.

Example 50: The subwoofer of Example 49, wherein the operations further comprise: receiving an indication of a remaining power level of a energy storage of the play back device, wherein determining the crossover frequency comprises determining the crossover frequency based on the received indication of the remaining power level of the energy storage of the play back device.

Example 51. An energy harvester device comprising: one or more processors: an energy harvester configured to capture energy from one or more energy sources in the environment: a wireless power transmitter configured to transmit power wirelessly to one or more external audio playback devices within the environment; and data storage having instructions stored thereon that, when executed by the one or more processors, cause the device to perform operations comprising: determine a power parameter of the device, the power parameter characterizing one or more of: energy captured via the energy harvester, an energy storage level of an energy storage of the energy harvester device, power consumed via the device, power transmitted via the wireless power transmitter, an energy storage level of the one or more external audio playback devices, or power consumed via the one or more audio playback devices; and based on the power parameter, modifying operation of the energy harvester device.

Example 52. The energy harvester device of any one of the preceding Examples, wherein modifying operation of the energy harvester device comprises one or more of: modifying an amount or duration or wireless power transmission: modifying a selection of external audio playback devices designated for receiving the wireless power transmitted; modifying audio playback via one or more audio transducers of the energy harvester device; disabling one or more microphones of the energy harvester device: or placing the energy harvester device in an idle mode.

Example 53. The energy harvester device of any one of the preceding Examples, wherein the operations further comprise modifying operation of at least one of the one or more external audio playback devices based at least in part on the power parameter, wherein modifying operation of at least one of the one or more external audio playback devices comprises: modifying audio playback via at least one of the one or more external audio play back devices: disabling one or more microphones of at least one of the one or more external audio playback devices: or placing at least one of the one or more external audio playback devices in an idle mode.

Example 54. The energy harvester device of any one of the preceding Examples, further comprising a wireless power receiver configured to receive power wirelessly from one or more external transmitter devices within the environment, wherein the operations further comprise: based on the power parameter, transitioning between (i) a wireless power transmission mode in which the energy harvester device transmits wireless power to the one or more external audio playback devices within the environment and (ii) a wireless power receiver mode in which the energy harvester device receives wireless power from one or more external transmitter devices within the environment.

Example 55. The energy harvester device of any one of the preceding Examples, wherein the operations further comprise: detecting a user presence in the environment; and based on the user presence detection, ceasing wireless power transmission via the wireless power transmitter.

Example 56. The energy harvester device of any one of the preceding Examples, wherein the operations further comprise transmitting wireless power only to external audio play back devices within a defined energy zone group.

Example 57. The energy harvester device of any one of the preceding Examples, wherein the operations further comprise forming the energy zone group based at least in part on proximity of the energy harvester device to the one or more external audio playback devices.

Example 58. The energy harvester device of any one of the preceding Examples, wherein proximity of the energy harvester device to the one or more external audio playback devices is determined based at least in part on one or more of: a signal strength of wireless power transmission between devices, a time-of-flight measurement between devices, or acoustic localization signals transmitted between devices.

Example 59. The energy harvester device of any one of the preceding Examples, wherein the energy zone group formation is independent of audio playback responsibilities of the external audio playback devices.

Example 60. The energy harvester device of any one of the preceding Examples, wherein the energy group includes a plurality of audio playback devices each having one or more microphones, the operations further comprising: designating a first audio play back device within the energy group for processing voice input from a user that is captured via its one or more microphones; and causing a second audio playback device within the energy group to transition to an idle state in which voice input from a user is not processed.

Example 61. The energy harvester device of any one of the preceding Examples, wherein the energy harvester is configured to capture power from at least one of: solar energy, thermal energy, salinity gradients, or kinetic energy.

Example 62. The energy harvester device of any one of the preceding Examples, wherein the energy harvester comprises at least one of: a photovoltaic cell, a thermoelectric generator, a wind turbine, electroacoustic transducers, or a piezoelectric crystal.

Example 63. The energy harvester device of any one of the preceding Examples, wherein the wireless power transmitter is configured to wirelessly transmit power to the one or more external audio playback devices via one or more of: optical electromagnetic transmission (e.g., infrared, visible, ultraviolet), sonic transmission, WiFi transmission, radiofrequency (RF) transmission, or magnetic resonance.

Example 64. The energy harvester device of any one of the preceding Examples, wherein the wireless power transmitter is configured to wirelessly transmit power to the one or more external audio playback devices over a distance of greater than about 10 cm, 50 cm, or 1 m.

Example 65. The energy harvester device of any one of the preceding Examples, wherein the operations further comprise, based at least in part on the power parameter, outputting guidance to a user regarding device positioning within the environment.

Example 66. A method comprising: determining a power parameter of an energy harvester device comprising an energy harvester and a wireless power transmitter, the power parameter characterizing one or more of: energy captured via the energy harvester, an energy storage level of an energy storage of the energy harvester device, power consumed via the energy harvester device, power transmitted via the wireless power transmitter, an energy storage level of the one or more external audio playback devices, or power consumed via the one or more external audio playback devices; and based on the power parameter, modifying operation of the energy harvester device.

Example 67. The method of any one of the preceding Examples, wherein modifying operation of the energy harvester device comprises one or more of: modifying an amount or duration or wireless power transmission: modifying a selection of external audio playback devices designated for receiving the wireless power transmitted: modifying audio playback via one or more audio transducers of the energy harvester device: disabling one or more microphones of the energy harvester device: or placing the energy harvester device in an idle mode.

Example 68. The method of any one of the preceding Examples, further comprising modifying operation of at least one of the one or more external audio playback devices based at least in part on the power parameter, wherein modifying operation of at least one of the one or more external audio playback devices comprises: modifying audio playback via at least one of the one or more external audio playback devices: disabling one or more microphones of at least one of the one or more external audio playback devices: or placing at least one of the one or more external audio playback devices in an idle mode.

Example 69. The method of any one of the preceding Examples, wherein the energy harvester device further comprises a wireless power receiver configured to receive power wirelessly from one or more external transmitter devices within the environment, wherein the method further comprises: based on the power parameter, transitioning between (i) a wireless power transmission mode in which the energy harvester device transmits wireless power to the one or more external audio playback devices within the environment and (ii) a wireless power receiver mode in which the energy harvester device receives wireless power from one or more external transmitter devices within the environment.

Example 70. The method of any one of the preceding Examples, further comprising: detecting a user presence in the environment; and based on the user presence detection, ceasing wireless power transmission via the wireless power transmitter.

Example 71. The method of any one of the preceding Examples, further comprising transmitting wireless power only to external audio playback devices within a defined energy zone group.

Example 72. The method of any one of the preceding Examples, further comprising forming the energy zone group based at least in part on proximity of the energy harvester device to the one or more external audio playback devices.

Example 73. The method of any one of the preceding Examples, wherein proximity of the energy harvester device to the one or more external audio playback devices is determined based at least in part on one or more of: a signal strength of wireless power transmission between devices, a time-of-flight measurement between devices, or acoustic localization signals transmitted between devices.

Example 74. The method of any one of the preceding Examples, wherein the energy zone group formation is independent of audio playback responsibilities of the external audio play back devices.

Example 75. The method of any one of the preceding Examples, wherein the energy group includes a plurality of audio playback devices each having one or more microphones, the method further comprising: designating a first audio playback device within the energy group for processing voice input from a user that is captured via its one or more microphones; and causing a second audio playback device within the energy group to transition to an idle state in which voice input from a user is not processed.

Example 76. The method of any one of the preceding Examples, wherein the energy harvester is configured to capture power from at least one of: solar energy, thermal energy, salinity gradients, or kinetic energy.

Example 77. The method of any one of the preceding Examples, wherein the energy harvester comprises at least one of: a photovoltaic cell, a thermoelectric generator, a wind turbine, electroacoustic transducers, or a piezoelectric crystal.

Example 78. The method of any one of the preceding Examples, wherein the wireless power transmitter is configured to wirelessly transmit power to the one or more external audio playback devices via one or more of: optical electromagnetic transmission (e.g., infrared, visible, ultraviolet), WiFi transmission, sonic transmission, radiofrequency (RF) transmission, or magnetic resonance.

Example 79. The method of any one of the preceding Examples, further comprising transmitting wireless power to the one or more external audio playback devices via the wireless power transmitter over a distance of greater than about 10 cm, 50 cm, or 1 m.

Example 80. The method of any one of the preceding Examples, further comprising, based at least in part on the power parameter, outputting guidance to a user regarding device positioning within the environment.

Example 81. Tangible, non-transitory computer-readable medium storing instructions that, when executed by one or more processors of an energy harvester device comprising an energy harvester and a wireless power transmitter, cause the energy harvester device to perform operations comprising: determining a power parameter of the energy harvester device, the power parameter characterizing one or more of: energy captured via the energy harvester, an energy storage level of an energy storage of the energy harvester device, power consumed via the energy harvester device, power transmitted via the wireless power transmitter, an energy storage level of the one or more external audio playback devices, or power consumed via the one or more external audio playback devices; and based on the power parameter, modifying operation of the energy harvester device.

Example 82. The computer-readable medium of any one of the preceding Examples, wherein modifying operation of the energy harvester device comprises one or more of: modifying an amount or duration or wireless power transmission: modifying a selection of external audio playback devices designated for receiving the wireless power transmitted; modifying audio playback via one or more audio transducers of the energy harvester device: disabling one or more microphones of the energy harvester device: or placing the energy harvester device in an idle mode.

Example 83. The computer-readable medium of any one of the preceding Examples, wherein the operations further comprise modifying operation of at least one of the one or more external audio playback devices based at least in part on the power parameter, wherein modifying operation of at least one of the one or more external audio playback devices comprises: modifying audio playback via at least one of the one or more external audio play back devices: disabling one or more microphones of at least one of the one or more external audio playback devices: or placing at least one of the one or more external audio playback devices in an idle mode.

Example 84. The computer-readable medium of any one of the preceding Examples, further comprising a wireless power receiver configured to receive power wirelessly from one or more external transmitter devices within the environment, wherein the operations further comprise: based on the power parameter, transitioning between (i) a wireless power transmission mode in which the energy harvester device transmits wireless power to the one or more external audio playback devices within the environment and (ii) a wireless power receiver mode in which the energy harvester device receives wireless power from one or more external transmitter devices within the environment.

Example 85. The computer-readable medium of any one of the preceding Examples, wherein the operations further comprise: detecting a user presence in the environment; and based on the user presence detection, ceasing wireless power transmission via the wireless power transmitter.

Example 86. The computer-readable medium of any one of the preceding Examples, wherein the operations further comprise transmitting wireless power only to external audio playback devices within a defined energy zone group.

Example 87. The computer-readable medium of any one of the preceding Examples, wherein the operations further comprise forming the energy zone group based at least in part on proximity of the energy harvester device to the one or more external audio playback devices.

Example 88. The computer-readable medium of any one of the preceding Examples, wherein proximity of the energy harvester device to the one or more external audio playback devices is determined based at least in part on one or more of: a signal strength of wireless power transmission between devices, a time-of-flight measurement between devices, or acoustic localization signals transmitted between devices.

Example 89. The computer-readable medium of any one of the preceding Examples, wherein the energy zone group formation is independent of audio playback responsibilities of the external audio playback devices.

Example 90. The computer-readable medium of any one of the preceding Examples, wherein the energy group includes a plurality of audio playback devices each having one or more microphones, the operations further comprising: designating a first audio play back device within the energy group for processing voice input from a user that is captured via its one or more microphones; and causing a second audio playback device within the energy group to transition to an idle state in which voice input from a user is not processed.

Example 91. The computer-readable medium of any one of the preceding Examples, wherein the energy harvester is configured to capture power from at least one of: solar energy, thermal energy, salinity gradients, or kinetic energy.

Example 92. The computer-readable medium of any one of the preceding Examples, wherein the energy harvester comprises at least one of: a photovoltaic cell, a thermoelectric generator, a wind turbine, electroacoustic transducers, or a piezoelectric crystal.

Example 93. The computer-readable medium of any one of the preceding Examples, wherein the wireless power transmitter is configured to wirelessly transmit power to the one or more external audio playback devices via one or more of: optical electromagnetic transmission (e.g., infrared, visible, ultraviolet), WiFi transmission, sonic transmission, radiofrequency (RF) transmission, or magnetic resonance.

Example 94. The computer-readable medium of any one of the preceding Examples, wherein the wireless power transmitter is configured to wirelessly transmit power to the one or more external audio playback devices over a distance of greater than about 10 cm. 50 cm, or 1 m.

Example 95. The computer-readable medium of any one of the preceding Examples, wherein the operations further comprise, based at least in part on the power parameter, outputting guidance to a user regarding device positioning within the environment.

Example 96. The energy harvester device of any one of the preceding Examples, wherein the device further comprises an energy storage.

Example 97. A system comprising: a wearable audio playback device configured to be worn in and/or over an ear of a user, the wearable audio playback device comprising: an audio transducer; and a wireless power receiver; and an accessory power device configured to be worn by the user, the accessory power device comprising: a network interface: an energy storage component: a wireless power transmitter: one or more processors; and data storage having instructions stored thereon that, when executed by the one or more processors, cause the accessory power device to perform operations comprising: transmitting, via the wireless power transmitter, power from the accessory power device to the wireless power receiver of the wearable audio playback device: receiving, via the network interface, audio content; and causing the wearable audio playback device to play back the audio content via the audio transducer.

Example 98. The system of any one of the Examples herein, wherein the wearable audio playback device comprises one or more of: in-ear earbuds, on-ear headphones, over-ear headphones, or smartglasses or a headset with integrated audio output.

Example 99. The system of any one of the Examples herein, wherein the accessory power device comprises a housing configured to be worn about a user's neck, on a user's wrist, on a user's head, clipped onto a user's clothing, fastened to a user's ear, or integrated into smartglasses.

Example 100. The system of any one of the Examples herein, wireless the wireless power receiver comprises a coil, and wherein transmitting, via the wireless power transmitter, energy from the accessory power device to the wireless power receiver of the wearable audio play back device involves electromagnetic coupling between the wireless power transmitter and the coil.

Example 101. The system of any one of the Examples herein, wherein causing the wearable audio playback device to play back the audio content via the audio transducer comprises transmitting the audio content to the wearable audio playback device using a wireless power transfer signal emitted by the wireless power transmitter as a carrier wave.

Example 102. The system of any one of the Examples herein, wherein causing the wearable audio playback device to play back the audio content via the audio transducer comprises transmitting the audio content to the wearable audio playback device via the network interface.

Example 103. The system of any one of the Examples herein, wherein transmitting, via the wireless power transmitter, power from the accessory power device to the wireless power receiver of the wearable audio playback device comprises transmitting less than 1 watt of power.

Example 104. The system of any one of the Examples herein, wherein the energy storage component of the accessory power device comprises a first energy storage component, and wherein the wearable audio playback device comprises a second energy storage component having a lower energy storage capacity than the first energy storage component.

Example 105. A method comprising: transmitting, via a wireless power transmitter, power from a wearable accessory power device to a wireless power receiver of a wearable audio playback device: receiving, via a network interface of the accessory power device, audio content; and causing the wearable audio playback device to play back the audio content via an audio transducer of the wearable audio playback device.

Example 106. The method of any one of the Examples herein, wherein the wearable audio playback device comprises one or more of: in-ear earbuds, on-ear headphones, over-ear headphones, or smartglasses or a headset with integrated audio output.

Example 107. The method of any one of the Examples herein, wherein the accessory power device comprises a housing configured to be worn about a user's neck, on a user's wrist, on a user's head, clipped onto a user's clothing, fastened to a user's ear, or integrated into smartglasses.

Example 108. The method of claim 9, wireless the wireless power receiver comprises a coil, and wherein transmitting, via the wireless power transmitter, energy from the accessory power device to the wireless power receiver of the wearable audio playback device involves electromagnetic coupling between the wireless power transmitter and the coil.

Example 109. The method of any one of the Examples herein, wherein causing the wearable audio playback device to play back the audio content via the audio transducer comprises transmitting the audio content to the wearable audio playback device using a wireless power transfer signal emitted by the wireless power transmitter as a carrier wave.

Example 110. The method of any one of the Examples herein, wherein causing the wearable audio playback device to play back the audio content via the audio transducer comprises transmitting the audio content to the wearable audio playback device via the network interface.

Example 111. The method of any one of the Examples herein, wherein transmitting, via the wireless power transmitter, power from the accessory power device to the wireless power receiver of the wearable audio playback device comprises transmitting less than 1 watt of power.

Example 112. The method of any one of the Examples herein, wherein an energy storage component of the accessory power device has a greater energy storage capacity than an energy storage component of the wearable audio playback device.

Example 113. One or more tangible, non-transitory computer-readable media storing instructions that, when executed by one or more processors of a media playback system, cause the system to perform operations comprising: transmitting, via a wireless power transmitter, power from a wearable accessory power device to a wireless power receiver of a wearable audio playback device: receiving, via a network interface of the accessory power device, audio content; and causing the wearable audio playback device to play back the audio content via an audio transducer of the wearable audio playback device.

Example 114. The one or more computer-readable media of any one of the Examples herein, wherein the wearable audio playback device comprises one or more of: in-ear earbuds, on-ear headphones, over-ear headphones, or smartglasses or a headset with integrated audio output.

Example 115. The one or more computer-readable media of any one of the Examples herein, wherein the accessory power device comprises a housing configured to be worn about a user's neck, on a user's wrist, on a user's head, clipped onto a user's clothing, fastened to a user's ear, or integrated into smartglasses.

Example 116. The one or more computer-readable media of any one of the Examples herein, wireless the wireless power receiver comprises a coil, and wherein transmitting, via the wireless power transmitter, energy from the accessory power device to the wireless power receiver of the wearable audio playback device involves electromagnetic coupling between the wireless power transmitter and the coil.

Example 117. The one or more computer-readable media of any one of the Examples herein, wherein causing the wearable audio playback device to play back the audio content via the audio transducer comprises transmitting the audio content to the wearable audio playback device using a wireless power transfer signal emitted by the wireless power transmitter as a carrier wave.

Example 118. The one or more computer-readable media of any one of the Examples herein, wherein causing the wearable audio playback device to play back the audio content via the audio transducer comprises transmitting the audio content to the wearable audio playback device via the network interface.

Example 119. The one or more computer-readable media of any one of the Examples herein, wherein transmitting, via the wireless power transmitter, power from the accessory power device to the wireless power receiver of the wearable audio playback device comprises transmitting less than 1 watt of power.

Example 120. The one or more computer-readable media of any one of the Examples herein, wherein an energy storage component of the accessory power device has a greater energy storage capacity than an energy storage component of the wearable audio playback device.

1-23. (canceled)

24. A media playback system comprising:
a first audio playback device comprising one or more first audio transducers and one or more first processors;
a second audio playback device comprising one or more second audio transducers, one or more second processors, and an energy storage having a remaining power level; and
one or more computer-readable media storing instructions that, when executed by the one or more first processors and/or the one or more second processors of the media playback system, cause the media playback system to perform operations comprising:
transmitting power from the first audio playback device to the energy storage of the second audio playback device;
receiving, via the first audio playback device, audio data from a content source;
determining, based on the remaining power level of the energy storage of the second audio playback device, a crossover frequency;
transmitting a second portion of the audio data via the first audio playback device to the second audio playback device, wherein the second portion of the audio data comprises audio frequencies greater than the determined crossover frequency;
playing back, via the first audio playback device, a first portion of the audio data comprising audio frequencies less than the crossover frequency; and
playing back, via the second audio playback device, the second portion of the audio data in synchrony with playback of the first portion of the audio data via the first audio playback device.

25. The media playback system of claim 24, wherein the first audio playback device is a subwoofer, and wherein the second audio playback device is a portable playback device.

26. The media playback system of claim 25, further comprising a power cable coupling the first audio playback device and the second audio playback device, and wherein transmitting power from the first audio playback device to the second audio playback device comprises transmitting power from the first audio playback device to the energy storage of the second audio playback device via the power cable.

27. The media playback system of claim 24, wherein providing power from the first audio playback device to the second audio playback device comprises wirelessly transmitting power from the first audio playback device to the energy storage of the second audio playback device.

28. The media playback system of claim 24, wherein the operations further comprise varying a rate of power transmission from the first audio playback device to the second audio playback device based at least in part on or more of: the audio data, a playback volume of the second audio playback device, and/or a power level of the energy storage of the second audio playback device.

29. The media playback system of claim 24, wherein the energy storage comprises at least one of: a battery or a capacitor.

30. The media playback system of claim 24, wherein the second audio playback device has a width, a height, and a depth, wherein the depth is the smallest dimension and is less than about 4 inches.

31. The media playback system of claim 24, further comprising a wall-mountable bracket configured to removably receive the second audio playback device thereon.

32. The media playback system of claim 24, further comprising a third audio playback device comprising one or more third audio transducers, one or more third processors, and a second energy storage, wherein the operations further comprise:
transmitting at least a portion of the audio data from the first audio playback device to the third audio playback device; and
playing back, via the third audio playback device and in synchrony with the first and second audio playback devices, only a third portion of the audio data, wherein the third portion of the audio data comprises audio frequencies greater than the determined crossover frequency.

33. The media playback system of claim 32, wherein the operations further comprise transmitting power from the first audio playback device to the third audio playback device.

34. The media playback system of claim 24, further comprising a third audio playback device comprising one or more third audio transducers, one or more third processors, and a second energy storage, wherein the operations further comprise:
transmitting power from the first audio playback device to the second energy storage of the third audio playback device;
receiving, via the third audio playback device, second audio content from a content source; and
playing back, via the third audio playback device and in synchrony with the first and second audio playback devices, at least a portion of the second audio content.

35. The media playback system of claim 24, wherein the operations further comprise:
determining that the energy storage level of the second audio playback device is less than a predetermined threshold; and
ceasing, based on the determination that the energy storage level of the second audio playback device is less than the predetermined threshold, playback of both the first and second audio playback devices.

36. The media playback system of claim 24, wherein the operations further comprise ceasing, prior to transmitting the second portion of the audio data via the first audio playback device to the second audio playback device, transmission of the power from the first audio playback device to the energy storage of the second audio playback device.

37. The media playback system of claim 24, wherein the operations further comprise:
receiving an indication of a position of a listener within a predetermined threshold distance of either the first audio playback device or the second audio playback device; and
ceasing, based on the received indication of the listener position, transmission of the power from the first audio playback device to the energy storage of the second audio playback device.

38. The media playback system of claim 24, wherein the determining the crossover frequency comprises comparing operational characteristics of the one or more first transducers and the one or more second transducers.

39. The media playback system of claim 24, wherein transmitting at least the second portion of the audio data via the first audio playback device to the second audio playback device comprises transmitting individual delays associated with corresponding ones of the one or more second audio transducers.

40. A method comprising:
transmitting power from a first audio playback device to an energy storage of a second audio playback device;
receiving, via the first audio playback device, audio data from a content source;
determining, based on the remaining power level of the energy storage of the second audio playback device, a crossover frequency;
transmitting a second portion of the audio data via the first audio playback device to the second audio playback device, wherein the second portion of the audio data comprises audio frequencies greater than the determined crossover frequency;
playing back, via the first audio playback device, a first portion of the audio data comprising audio frequencies less than the crossover frequency; and
playing back, via the second audio playback device, the second portion of the audio data in synchrony with playback of the first portion of the audio data via the first audio playback device.

41. The method of claim 40, wherein the first audio playback device is a subwoofer, and wherein the second audio playback device is a portable playback device.

42. A subwoofer comprising:
one or more audio transducers;
a power transmitter;
one or more processors; and
one or more computer-readable media storing instructions that, when executed by the one or more processors, cause the subwoofer to perform operations comprising:
transmitting, via the power transmitter, power to a playback device;
receiving, via the subwoofer, audio data from a content source;
determining a crossover frequency;
transmitting, to the playback device, a second portion of the audio data, wherein the second portion of the audio data comprises audio frequencies greater than the determined crossover frequency; and
causing playback of the second portion of the audio data via the playback device in synchrony with playback of a first portion of the audio data via the subwoofer, wherein the first portion of the audio data comprises audio frequencies less than the determined crossover frequency.

43. The subwoofer of claim 42, wherein the instructions cause the subwoofer to perform operations comprising:
receiving an indication of a remaining power level of an energy storage of the playback device,
wherein determining the crossover frequency comprises determining the crossover frequency based on the received indication of the remaining power level of the energy storage of the playback device.
